(19) United States
(12) Patent Application Publication
(10) Pub. No.: US 2006/0047593 A1
(43) Pub. Date: Mar. 2, 2006

(54) Method and system for funds management

(75) Inventors: Thomas C. Naratil, Warren, NJ (US); Marianne Freer, Lincoln Park, NJ (US)

Correspondence Address: PILLSBURY WINTHROP SHAW PITTMAN, LLP, P.O. BOX 10500, MCLEAN, VA, 22102, US

(73) Assignee: UBS Financial Services Inc., Weehawken, NJ (US)

(21) Appl. No.: 10/931,300

(22) Filed: Sep. 1, 2004

(51) Int. Cl. G06Q 40/00

(52) U.S. Cl. 705/35

(57) ABSTRACT

Methods and systems for sweeping fund between accounts are provided. A first account is initialized with a balance. The number of withdrawals made from the first account is monitored with respect to a limit on the total number of withdrawals allowed within each cycle of a predetermined period. Upon reaching the limit on the total number of withdrawals, the remaining balance in the first account is swept into a second account. Each subsequent withdrawal is made from the second account during the remaining duration of the cycle after the remaining balance is swept into the second account. When a new cycle begins, the entire remaining balance in the second account is swept back into the first account.

### BACKGROUND OF THE INVENTION

1. Field of Invention

The present invention relates to a system and method for managing funds. More specifically, the present invention relates to a system and method for sweeping client funds between accounts.

2. Discussion of Related Art

Certain types of financial accounts are insured. For example, some accounts may be insured by the Federal Deposit Insurance Corporation (FDIC). FDIC may offer different types of insurance, and each may be applied to different types of accounts. For instance, bank deposits may be insured through Bank Insurance Fund (BIF) while deposits in saving institutions may be insured under the FDIC's Savings Association Insurance Fund (SAIC). FDIC's insurance provides a coverage based on ownership and the amount of insurance provided to each owner. Owners may have multiple accounts in each institution. Usually, FDIC insurance coverage is $100,000 for each single ownership account and $200,000 for each joint ownership account.

Some of such insured accounts may be subject to further restrictions. For example, a money market deposit account (MMDA) is usually subject to a limit on the number of withdrawals within each cycle of a fixed period (e.g., one month). Certain percentage of funds may be required to be retained in a negotiable order of withdrawal (NOW) account. These restrictions may lead to undesirable effects to different parties. For example, the constraint on number of withdrawals within each month on an MMDA account may limit what the owner of the MMDA account can do and how the owner should handle transactions related to the MMDA account. The requirement of retaining certain percentage of funds in an NOW account may significantly reduce the amount of flexible fund that an institution (where the NOW account resides) can use to invest on a daily basis.

### SUMMARY OF THE INVENTION

In accordance with at least one embodiment of the invention, systems and methods are provided to manage client funds. Specifically, sweep methods and systems are provided to sweep funds between accounts.

In one embodiment, two accounts, a first account and a second account, may be set up in relation to a client for sweep purposes. There may be a limit imposed on the first account that restricts the number of withdrawals within each cycle of a predetermined period. For example, the limit may be that only 6 withdrawals are permitted within each month. In this embodiment, there may be no similar withdrawal limitation on the second account. However, there may be a requirement to retain certain percentage of the fund in the second account. The fund in either the first or the second account may be insured.

In this embodiment, the first account may correspond to an MMDA account and the second account may correspond to an NOW account. A sweep method is described that may sweep the fund between the MMDA and the NOW accounts so that the number of withdrawals from the MMDA does not exceeds the limit and the fund swept to the NOW account is minimum. According to this sweep method, during each cycle (e.g., each month), the client's fund may be initially set up in the MMDA account. When a withdrawal request is received, the withdrawal may be made from the MMDA account. This may continue until the number of withdrawals reaches the given limit. When this occurs, the fund may be swept from the MMDA to the NOW account. All subsequent withdrawals during the same cycle may be made from the NOW account. When a new cycle starts, the fund in the NOW account may be swept back into the MMDA.

In another embodiment, at least three accounts may be set up in relation to a client for sweep purposes. A first account may correspond to a MMDA account and a second account may correspond to an NOW account. Similarly, the MMDA may be subject to a limit on the number of withdrawals during each cycle of a predetermined period. The total balance in the MMDA and the NOW accounts may be insured up to a cap amount. To ensure that the total balance in the first and the second account does not exceeds the cap, a third account may be set up according to the client's election. When the total balance in the first and the second account reaches the cap, a deposit may be made to the third account. When there is a positive balance exceeding a threshold in the third account, a withdrawal may be made from the third account prior to making a withdrawal from the first or the second account. At the same time, the limit on the number of withdrawals made from the MMDA may be enforced.

In accordance with another aspect of the present invention, a framework may be provided to facilitate a sweep service. The framework may be configured to enable a service provider to offer one or more types of sweep services to a plurality of clients. The framework may support different interface means through which a client may interact with a sweep service to conduct different transactions or inquiries. In addition, the framework may also provide backend support for data storage, retrieval, and processing and integrate a sweep service with accounting and data management functionalities. Furthermore, the framework may be configured to enable a service provide to generate reports in compliance with governmental regulations.

### BRIEF DESCRIPTION OF THE DRAWINGS

The invention claimed and/or described herein is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 describes a sweep method between accounts, according to at least one embodiment of the present invention;

FIG. 2 depicts an exemplary mechanism that facilitates financial transactions and sweeps funds between accounts within the constraint of a limit on the number of withdrawals within a cycle of a pre-determined period, according to at least one embodiment of the present invention;

FIG. 3 depicts an exemplary mechanism that facilitates transaction aggregation to determine net transactions, according to at least one embodiment of the present invention;

FIG. 4 depicts a detailed exemplary functional block diagram of an aggregation mechanism, according to at least one embodiment of the present invention;

FIG. 5 is a flowchart of an exemplary process, in which sweep between accounts is carried out based on net transactions, according to at least one embodiment of the present invention;

FIG. 6 is a flowchart of an exemplary process, in which a withdrawal transaction mechanism performs withdrawal and sweep based on an accumulated number of withdrawals during a cycle, according to at least one embodiment of the present invention;

FIG. 7 is a flowchart of an exemplary process, in which a deposit transaction mechanism performs a deposit into an associated account, according to at least one embodiment of the present invention;

FIG. 8 describes a further sweep method among different accounts, according to an embodiment of the present invention;

FIG. 9 depicts another exemplary mechanism that facilitates financial transactions within the constraints of a cap on an insured amount and a limit on the number of withdrawals within a predetermined period, according to an embodiment of the present invention;

FIG. 10 is a flowchart of an exemplary process, in which a deposit transaction mechanism facilitates net deposit transactions within the constraints of a cap on an insured amount and a limit on the number of withdrawals, according to an embodiment of the present invention;

FIG. 11 is a flowchart of an exemplary process, in which a withdrawal transaction mechanism facilitates net withdrawal transactions within the constraints of a cap on the insured amount and a limit on the number of withdrawals, according to an embodiment of the present invention;

FIG. 12 depicts an exemplary framework in which a sweep service is provided, according to an embodiment of the present invention;

FIGS. 13(a) and and 13(b) show different embodiments of a sweep service application, according to at least one embodiment of the present invention; and

FIG. 14 shows a computer system based on which a sweep service application is executed, according to at least one embodiment of the present invention.

### DETAILED DESCRIPTION

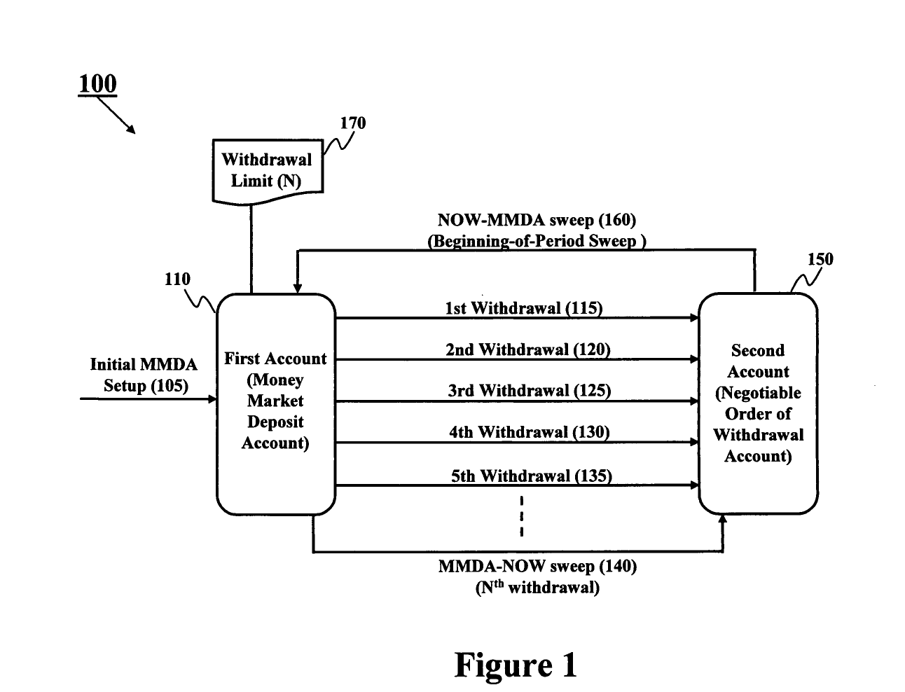

FIG. 1 describes a method 100 for sweeping funds between two accounts, according to at least one embodiment of the present invention. The method 100 may include a first account 110 and a second account 150. In one embodiment, the first account 110 may be a money market deposit account (MMDA), which is an insured account with a withdrawal limit 170 according to regulations. The withdrawal limit 170 may constrain the number of withdrawal transactions performed on the first account 170 to be N times within a cycle of a predetermined period. For example, a specific regulation may limit that each MMDA can have 6 (i.e., N=6) withdrawals within each month (i.e., the predetermined period is one month).

In one embodiment, the second account 150 may correspond to a negotiable order of withdrawal (NOW) account. There may be no limitation on the second account 150 in terms of allowed number of withdrawal transactions within a predetermined period. The second account may also be insured. There may be some regulations associated with the insured account and such regulations may be imposed on the second account 150. For example, the federal government may require that a certain percentage of the balance of the second account as a reserve.

Both the first account 110 and the second account 150 may be associated with a particular customer/client. Having both accounts for a single customer may serve the purposes of observing relevant regulations and at the same time, maximizing the cash available for investment at the financial institution where the accounts are set up. To operate the sweep method, the initial fund of the client may be first placed in the first account 110. If the first account 110 corresponds to an MMDA, an initial MMDA setup 105 may be performed. Then a cycle of a predetermined period (e.g., one month) may start.

A current cycle may begin from the date as the first account 110 is initially set up. For example, if an MMDA account in this scheme is set up on February 10 and a predetermined period is one month, then the current cycle may be between February 10 and March 10. In this case, different customers may have their cycles with different starting dates and ending dates, although all the customers may be subject to the same predetermined period (i.e., one month). A current cycle may also begin from the date of an already started cycle defined in a fixed manner. For example, if each calendar month is used as a predetermined cycle for all customers, each customer's current cycle starts the beginning of the current month and ends at the end of the month. For example, the current cycle in this case for the customer who initially sets up the first account 110 on February 10 is between February 1 and March 1.

The sweep method depicted in FIG. 1 may be effective to observe the limitation on the number of withdrawals made from the first account 110 and at the same time minimize the reserve required in the second account 150. At the beginning of the initial cycle (e.g., after the accounts are just set up), all the available funds may be placed in the first account 110. The accumulated number of withdrawals at this point is zero. When a first withdrawal (115) is requested, the fund may be moved from the first account 110 to the second account 150. The number of withdrawals may be incremented to one after the withdrawal. The same process may take place for the second withdrawal (120), the third (125), the fourth (130), the fifth (135). This may continue until the occurrence of a withdrawal that makes the accumulative number of withdrawals equal to the withdrawal limit 170 (N).

When the N^{th} withdrawal request within a current cycle is received, all the funds remaining in the first account 110 may be swept from the first account 110 to the second account 150. This is an MMDA to NOW sweep (140). The N^{th} withdrawal may then be made from the second account 150. From this point on within the same cycle, all subsequent withdrawals may be made from the second account 150.

When a new cycle begins, all the remaining funds in the second account 150 may be swept back to the first account 110. This is so called NOW to MMDA sweep (160) or beginning-of-period sweep. During this beginning of the period sweep, the number of withdrawals within this new cycle may be properly reset.

The sweep operation described in the above scheme refers to generic sweep operation. Depending on specific implementation of the first account 110 and the second account 150, the sweep may be carried out in different ways. If both the MMDA 110 and the NOW account 150 hold cash balance, the sweep operation may involve simply transfer of the cash balance. When the MMDA 110 holds the balance in the form of an investment fund (e.g., mutual funds or bonds), the sweep may involve different operations. For example, in order to sweep the balance from the MMDA 110 in the form of mutual funds, to the NOW account 150, the mutual funds in the MMDA 110 may be required to be liquidated (sold) first before moving the cash from the sale into the NOW account.

The form of the balance may be defined by different parties. For example, an institution that offers the sweep service may set up the service so that the first account holds only mutual funds and the second account holds only cash. That is, any money deposited in the first account has to be deposited in the form of mutual funds. In this case, the balance of the first account corresponds to the portfolio of the funds in the account. When the balance needs to be swept, the mutual funds have to be sold before the balance can be moved. Similarly, when the balance in the second account is to be swept back to the first account, the cash balance in the second account may be used to buy certain mutual funds and then the purchased shares are swept into the first account.

The choice of what funds to buy may be specified by the owner of the accounts (client). However, the institution from where the client receives the service may limit the range of choices that a client can select from.

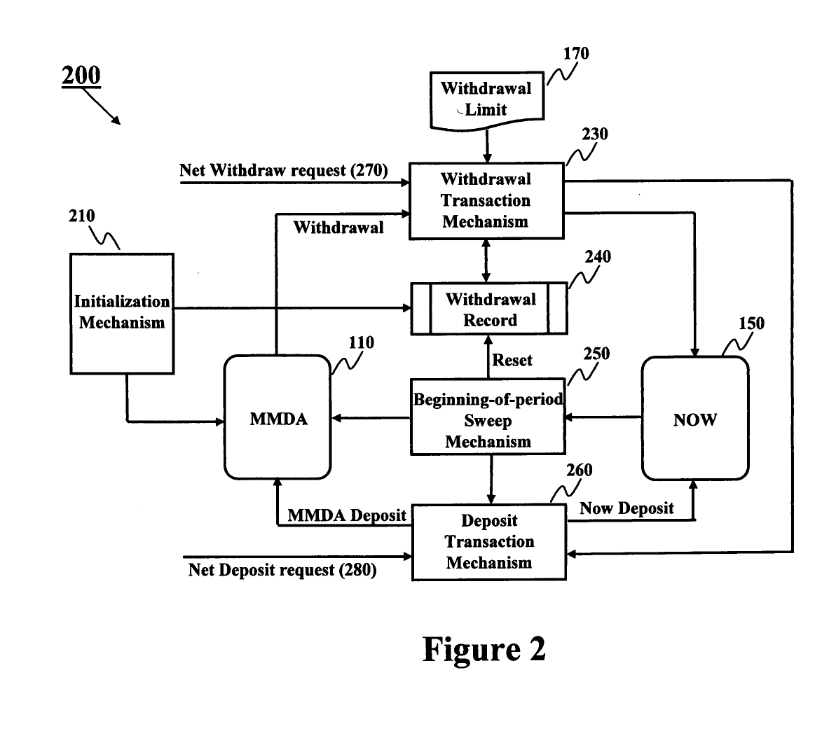

FIG. 2 depicts an exemplary system 200 that facilitates transaction activities between different accounts in compliance with the sweep method 100, according to at least one embodiment of the present invention. The system 200 may comprise an initialization mechanism 210, a withdrawal transaction mechanism 230, a withdrawal record 240, a beginning-of-period (BOP) sweep mechanism 250, and a deposit transaction mechanism 260.

The initialization mechanism 210 may initialize the MMDA account and the NOW account 150 when the account associated with a client is initially set up. The withdrawal record 240 may keep track of the number of withdrawals in each cycle of a predetermined period (e.g., one month). The withdrawal transaction mechanism 230 may monitor the withdrawal record 240 and conduct withdrawal transactions in compliance with the withdrawal limit 170. A withdrawal can be made either from the MMDA 110 or the NOW account 150, depending on where the fund should be placed at the time of the withdrawal. The deposit transaction mechanism 260 may perform deposit transactions in either the MMDA 110 or the NOW account 150 depending on where the fund is currently located. The BOP sweep mechanism 250 may sweep the remaining fund in the NOW account 150 back to the MMDA 110 at the beginning of each new cycle and then accordingly reset the withdrawal record 240.

The initialization mechanism 210 may set up the initial amount of fund in the MMDA 110. The fund may be from a direct deposit by means of a check deposit or a wired fund transfer from one or more financial institutions specified by the underlying client. The initialization may also include additional operations that are deemed necessary to set up the accounts properly. For example, the initialization mechanism 210 may conduct operations related to opening the two counterpart accounts, namely the MMDA 110 and the NOW account 150. To open accounts, the initialization mechanism 210 may collect client information first. Such information may be provided by some relevant sources (e.g., marketing department).

Alternatively, the initialization mechanism 210 may itself provide an interface that interacts with a client to whom the underlying sweep service is offered. Such an interface may be provided by means of a web page, marketing personnel, a sales (or courtesy) call, or a conventional postal mail. Through the interaction with the client, the initialization mechanism 210 may gather, directly from the client, the information necessary to open the accounts. Such information may include, but is not limited to, first name, last name, social security number, address, and other contact information including home phone number, work phone number, cellular phone number, or email address.

Other related information may also be communicated during the interaction. This may include the requirement of a minimum balance needed in the accounts and the conditions under which the fund is swept. The client may also specify the means to initialize the fund in the account. For example, the client may indicate from where the fund should be wired to the account and provide the authorization or that the account should be initialized using a client's personal check. Based on information gathered from the interaction with the client, directly or indirectly, the initialization mechanism 210 may set up the initial fund in the MMDA 110.

When the MMDA 110 and the NOW account 150 are initially set up, the withdrawal record may be initialized for the initial cycle. The withdrawal record 240 may be then incremented each time a withdrawal is made from the MMDA 110 within the same cycle. The number of withdrawals from the MMDA 110 within each cycle may be constrained according to the withdrawal limit 170. For example, the federal government may impose a restriction of maximal six withdrawals each month. In this case, the sweep method may, in at least one embodiment, allow a total of 6 withdrawals from the MMDA 110 in a month, and, at the 6^{th} withdrawal, the sweep method 100 described in FIG. 1 may sweep all the remaining funds in the MMDA 110 into the NOW account 150.

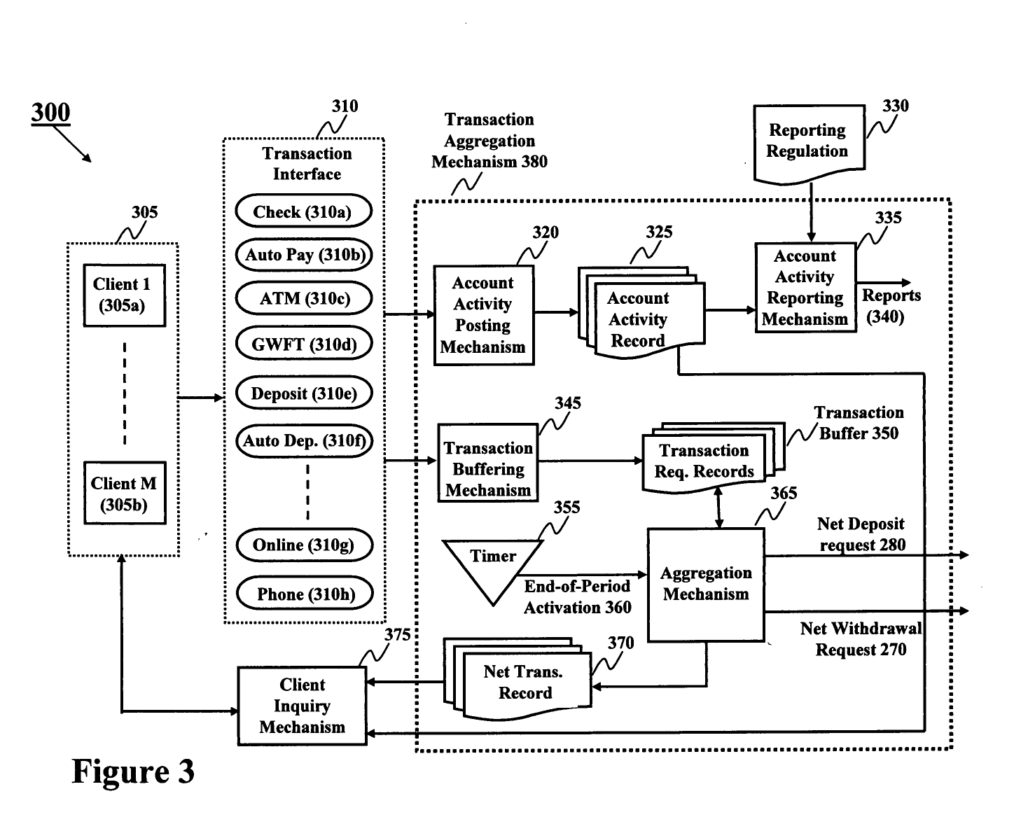

The withdrawal transaction mechanism 230 is responsible for conducting withdrawal transactions. The withdrawal transaction mechanism 230 may receive a withdrawal request 270 with a specific withdrawal amount. Such a request may be received from a different source based on the client's request. The request may correspond to an aggregated transaction with a net withdrawal amount instead of a single transaction request made by the client. Further details related to the aggregated transaction and net transaction are discussed with reference to FIG. 3 herein.

The withdrawal transaction mechanism 230 may monitor the state of the withdrawal record 240, which records an accumulative number of withdrawals from the MMDA 110 within a current cycle. Upon receiving a withdrawal transaction request, based on the current number of withdrawals and the withdrawal limit 170, the withdrawal transaction mechanism 230 may determine how the withdrawal is to be carried out and conduct the withdrawal accordingly.

If the current number of withdrawals indicated in the withdrawal record 240 is below the withdrawal limit 170, the withdrawal transaction mechanism 230 may simply make a withdrawal for the amount indicated in the withdrawal request 270 from the MMDA 110. In an embodiment, the withdrawal may be carried out by moving the withdrawal amount of fund from the MMDA 110 to the NOW account 150. In such embodiments, a withdrawal, to the client, is always made out of the NOW account 150. Other embodiments are also possible. After a withdrawal is made, the withdrawal transaction mechanism 230 may increment the withdrawal record 240 by one.

If the current number of withdrawals equals to the withdrawal limit set out in 170, the withdrawal transaction mechanism 240 may perform different operations. It may first sweep the entire remaining fund in the MMDA 110 into the NOW account 150 and then make a withdrawal for the requested withdrawal amount from the NOW account. After these operations, the withdrawal transaction mechanism 230 may then increment the withdrawal record 240 by one.

When the current number of withdrawals exceeds the withdrawal limit 170, the withdrawal transaction mechanism 230 may carry out the withdrawal request by making a withdrawal from the NOW account 150 and then increment the withdrawal record 240 by one.

At the beginning of each new cycle, the BOP sweep mechanism 250 may be activated to sweep the remaining fund in the NOW account 150 back to the MMDA 110 and reset the withdrawal record 240. As discussed earlier, a new cycle for each client may begin according to different criteria. In one embodiment, a new cycle may begin at the same time for all clients (e.g., beginning of each month). In a different embodiment, a new cycle may begin at different dates (or even time) for different clients, depending on the perspective dates on (or times at) which their services are initiated. In yet another different embodiment, a new cycle may begin on a particular day of a cycle (e.g., first day of a month) for all the clients who initiate their services during the first half of the cycle (one month) and begin on a different particular day (e.g., middle day of a month) for all the clients who initiate their services during the second half of the cycle.

Depending on the embodiment employed, the BOP sweep mechanism 250 may be implemented differently. If a cycle begins at the same time for all clients, the BOP sweep mechanism 250 may be activated simply by a global clock that produces an activation whenever a new cycle begins. If different clients have cycles of different starting and ending dates, the BOP sweep mechanism 250 may be activated based on information associated with the starting and ending date associated with each particular client.

The deposit transaction mechanism 260 may conduct deposit transactions. In at least one embodiment, the deposit transaction mechanism 260 may be activated or invoked through a deposit request 280, which indicates a deposit amount. Such a request may be received from a different source and constructed based on the client's request(s). Similar to the withdrawal request 270, the deposit request 280 may correspond to an aggregated transaction with a net deposit amount computed based on a plurality of transactions aggregated over a predetermine time frame (e.g., one day). It may also correspond to an actual transaction requested by the client. Further details related to the aggregated transaction and net transaction are discussed with reference to FIG. 3 herein.

The deposit transaction mechanism 260 may carry out a deposit transaction between the MMDA 110 and the NOW account 150, depending on where the fund associated with these accounts is currently located. The deposit transaction mechanism 260 may first determine, upon receiving the deposit request 280, whether the fund has been swept to the NOW account 150. There may be different ways to ascertain that. For example, a flag may be employed to indicate where the fund is located. Through this flag, the initialization mechanism 210 may set this flag, as part of the initialization procedure, to indicate that the fund is in the MMDA 110. The withdrawal transaction mechanism 230 may then update the flag to indicate that the fund has been swept to the NOW account 150 after its sweep operation upon reaching the withdrawal limit 170. The BOP sweep mechanism 250 may then reset the flag at the beginning of each cycle. In this embodiment, the deposit transaction mechanism 260 may make determination independent of the withdrawal limit 170.

Alternatively, the deposit transaction mechanism 260 may determine the location of the fund by examining the withdrawal record 240. When the recorded number of withdrawals exceeds the withdrawal limit 170, the fund is in the NOW account 150. Otherwise, the fund is in the MMDA 110. Once the fund location is determined, the deposit transaction mechanism 260 may make a deposit with the given deposit amount into one of the accounts.

The withdrawal record 240 may be realized via different means. For example, it may be realized as a counter in a register, a data structure in an application software, or a record in a database. The withdrawal record 240 may be both readable and writeable and accessible to different mechanisms in the system 200 such as the withdrawal transaction mechanism 230, the BOP sweeping mechanism 250, and the deposit transaction mechanism 260.

FIG. 3 depicts an exemplary framework 300 that may facilitate transaction aggregation and determine net transactions, according to an embodiment of the present invention. As discussed earlier, a transaction request, withdrawal or deposit, may be generated based on a plurality of transactions that are aggregated over a predetermined time frame. For example, all transaction requests made by the client over a time frame of one day may be aggregated into an aggregated transaction. The final aggregated transaction may correspond to a net withdrawal, if the aggregation yields a negative amount, or a net deposit, if the aggregation yields a positive amount. Such aggregated transactions may be carried out at the end of the predetermined time frame (e.g., at the end of each day).

Although individual transactions may be aggregated, records of such transactions may nevertheless be retained for different purposes. For example, such retained individual transaction records may be used to generate reports on transaction activities on each account to comply with certain regulations. In addition, such recorded individual transaction records may also be used to provide information in response to a client's inquiry. Similarly, records of aggregated transactions may also be retained for various purposes. The framework 300 may provide facilities to achieve the above-mentioned functionalities.

The framework 300 may further comprise a plurality of clients 305 (e.g., client 1 305a, . . . , client M 305b), a transaction interface 310, and a transaction aggregation mechanism 380. The transaction interface 310 may facilitate the clients 305 to request an individual transaction through one or more means, including but not limited to, through a check (310a), an automatic payment plan (310b), ATM (310c), generic wired fund transfer (GWFT 310d), deposit (310e), automatic deposit (310f), . . . , online request (310g), and personal request via phone (310h).

A client in the framework 300 may be broadly defined. A client may be an individual who has one or more accounts with a financial institute that offers the underlying sweep service. A client may also be a private business such as a retailer, an organization such as a club, a corporation such as a utility company or a telephone company. Each transaction request received may be directed to a specific account. For example, an individual may provide his account information to his telephone company to authorize the company to make withdrawal for the amount of service charge for each month. An individual may also provide account information to his employer to authorize the employer to automatically deposit monthly salary. In each such situation, the transaction request, although not from the person who holds the account, has to be made in association with an existing account. In other words, the transaction request made by a third party may be viewed as a transaction request made on behalf of the client who owns the account.

When individual transaction requests are received, they may be forwarded to the transaction aggregation mechanism 380 and are recorded. At the end of each time frame (e.g., end of each day), the transaction aggregation mechanism 380 may aggregate all the transaction requests made during the current time frame with respect to each account and determine whether the aggregation yields a net withdrawal or a net deposit.

The transaction aggregation mechanism 380 may comprise an account activity posting mechanism 320, a transaction buffering mechanism 345, a timer 355, and an aggregation mechanism 365. The account activity posting mechanism 320 may post every individual transaction request from a client as an account activity and record such information in an account activity record 325 associated with the account(s) of the client. Such retained information may serve to record the non-aggregated transaction information.

The transaction buffering mechanism 345, upon receiving a transaction request from a client, may buffer the request in a transaction buffer 350. The transaction buffer 350 may comprise a plurality of transaction request records, each of which may be associated with the account(s) of a particular client. Each transaction request record in the transaction buffer 350 may buffer the transaction requests from the associated client received during a predetermined time frame.

The timer 355 may activate the aggregation mechanism 365 at the end of each time frame. The timer 355 may be realized manually or automatically. In a manual mode, a human operator may carry out the activation task. For example, an officer at an investment institution or each branch of the institution may activate the aggregation mechanism everyday at certain hour. The timer 355 may also be implemented to activate in an automatic fashion. Such automated timer may be adjusted by a human operator.

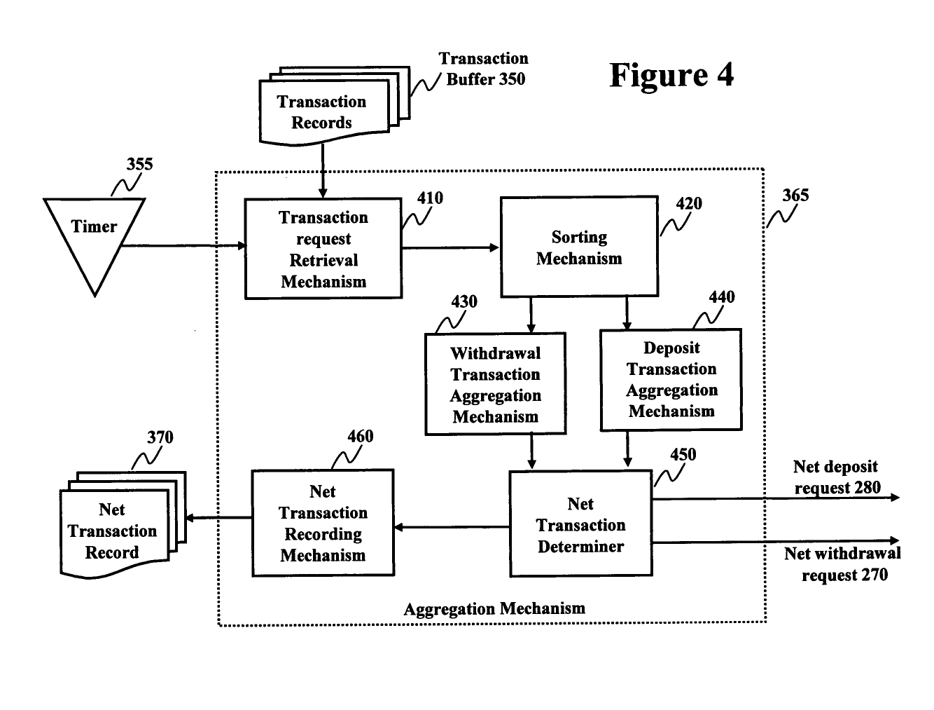

Once activated, the aggregation mechanism 365 may retrieve the buffered transaction requests associated with each account and to determine whether the aggregated effect of the individual transactions yields a net deposit or a net withdrawal. Further details of the aggregation mechanism 365 are discussed with reference to FIG. 4 herein. The computed net transaction may be recorded in a net transaction record 370 associated with the account.

The transaction aggregation mechanism 380 may optionally include an account activity reporting mechanism 335 that generates detailed transaction reports according to some reporting regulation 330, which can be either organizational or governmental. The framework 300 may also optionally provide a client inquiry mechanism 375 to enable clients 305 to query about transactions, including the detailed transactions and net transactions. The client inquiry mechanism 375, upon receiving a query from a client, may determine whether the client's request is related to detailed transactions or net transactions. In the former case, the client inquiry mechanism 375 may retrieve information from the account activity record 325. In the latter case, the client inquiry mechanism 375 may retrieve relevant information from the net transaction record 370.

FIG. 4 depicts a detailed exemplary functional block diagram of the aggregation mechanism 365, according to at least one embodiment of the present invention. The exemplary aggregation mechanism 365 may comprise a transaction request retrieval mechanism 410, a withdrawal transaction aggregation mechanism 430, a deposit transaction aggregation mechanism 440, a net transaction determiner 450, a net transaction recording mechanism 460, and optionally a sorting mechanism 420. Upon being activated, the transaction request retrieval mechanism 410 may retrieve the buffered transaction requests made during a given time frame associated with each account.

The retrieved transaction requests may be optionally sorted according to different criteria. For example, the retrieved transaction requests may be sorted according to accounts. Within each account, the transaction requests may be further sorted into withdrawal or deposit requests. The sorting mechanism 420 may separate withdrawal requests from deposit requests. The group of withdrawals may be sent to the withdrawal transaction aggregation mechanism 430 to compute an aggregated withdrawal. The group of deposits may be sent to the deposit transaction aggregation mechanism 440 to compute an aggregated deposit.

The aggregated withdrawal and the aggregated deposit may then be sent to the net transaction determiner 450 to determine whether the net transaction corresponds to a withdrawal or a deposit. If the aggregated withdrawal is larger than the aggregated deposit, the aggregated transaction is a net withdrawal with a net withdrawal amount obtained by subtracting the aggregated deposit from the aggregated withdrawal. If the aggregated withdrawal is smaller than the aggregated deposit, the aggregated transaction is a net deposit with a net deposit amount derived by subtracting the aggregated withdrawal from the aggregated deposit. If the aggregated withdrawal equals the aggregated deposit, there is no net transaction. Such computed net transaction may be sent to the net transaction recording mechanism 330, which further appropriately records such net transaction information in a net transaction record associated with the underlying account.

If the net transaction corresponds to a withdrawal, the net transaction determiner 450 may send a net withdrawal request 270 to activate the withdrawal transaction mechanism 230 (FIG. 2) to carry out the net withdrawal. If the net transaction corresponds to a deposit, the net transaction determiner 450 may send a net deposit request 280 to the deposit transaction mechanism 260 (FIG. 2) to carry out the net deposit. The net transaction amount (withdrawal or deposit) may be sent with the request.

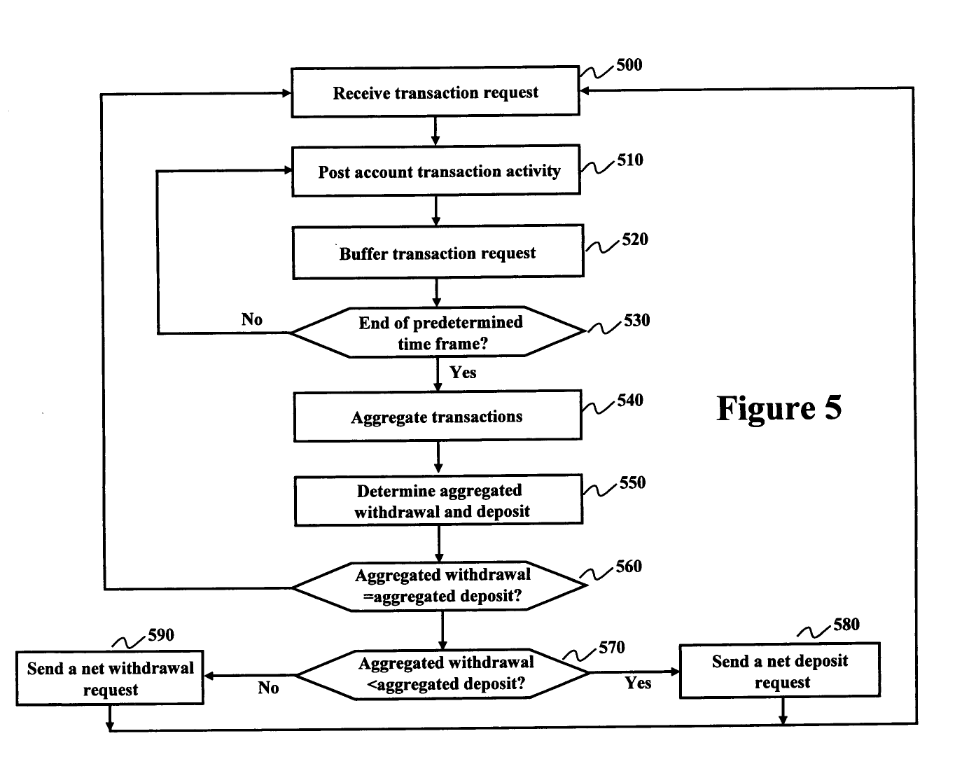

FIG. 5 is a flowchart of an exemplary process, in which sweep operations between two accounts may be carried out based on aggregated transactions, according to an embodiment of the present invention. A transaction request associated with an account may be first received, at 500. The received transaction request is posted, at 510, in the account activity record of the account and then buffered, at 520, in the transaction buffer 350 (FIG. 3). The recording and buffering operations may continue until the end of a predetermined time frame, determined at 530.

At the end of the current time frame, all the transaction requests received during the time frame with respect to an account may be aggregated at 540. The aggregated withdrawal and deposit may be then determined at 550. If the aggregated withdrawal amount equals to the aggregated deposit amount, determined at 560, no net transaction is performed and the process may return to 500 to handle transaction requests for the next time frame. If the two amounts are not equal, it may be further determined, at 570, whether the aggregated withdrawal amount is smaller than the aggregated deposit amount. If the aggregated withdrawal amount is smaller than the aggregated deposit amount, a net deposit transaction request (280) is sent at 580. Otherwise, a net withdrawal transaction request (270) is sent at 590. After the net transaction is carried out, the process may return to 500 to handle transaction requests for the next time frame.

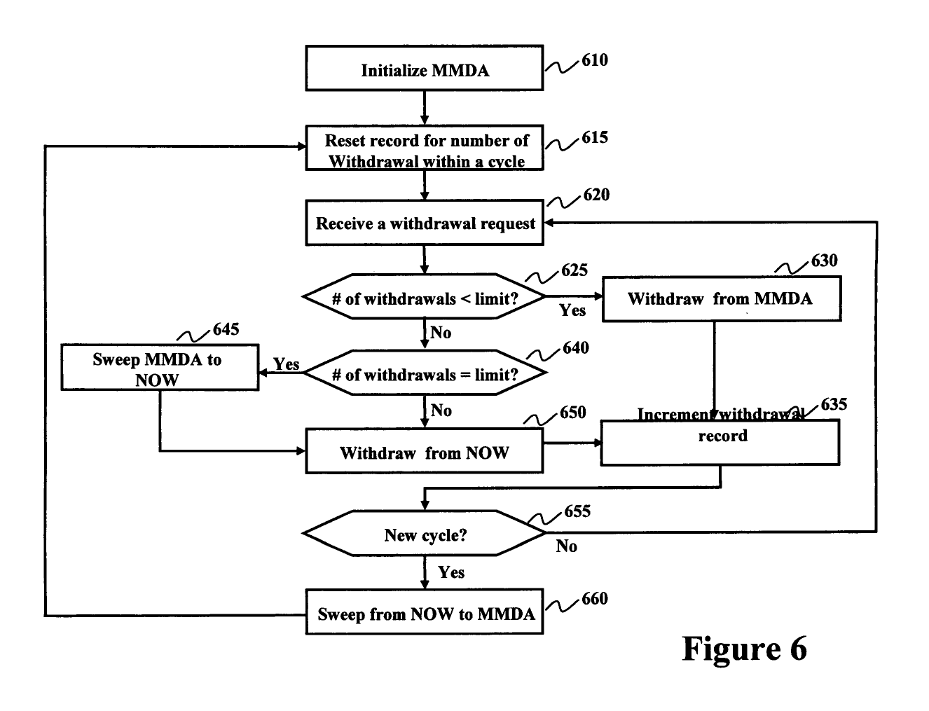

FIG. 6 is a flowchart of an exemplary process, in which net withdrawal transactions may be carried out between two accounts, according to at least one embodiment of the present invention. The MMDA 110 may be first initialized at 610. The withdrawal record 240 is set at 615 for a current cycle. When a net withdrawal request (270) is received at 620, it may be determined, at 625, whether the currently recorded number of withdrawals in the withdrawal record 240 is below the withdrawal limit 170.

If the withdrawal record 240 is below the withdrawal limit 170, the withdrawal transaction mechanism 230 may make a withdrawal, at 630, from the MMDA 110. As discussed earlier, specific operations performed during a withdrawal may depend on implementation details of an underlying sweep service. For instance, if the balance in the MMDA 110 is in a form of certain mutual funds, it may be necessary to first sell the mutual funds and then withdraw the cash from the sale to the NOW account. After the withdrawal operation, the withdrawal transaction mechanism 230 may increment, at 635, the withdrawal record 240.

If the withdrawal record 240 equals the withdrawal limit 170, determined at 640, the withdrawal transaction mechanism 230 may first sweep the remaining balance in the MMDA 110 into the counterpart NOW account 150. Similarly, the sweep operation here may involve selling, for example, mutual funds in the MMDA 110 and in which the cash from the sale is swept. After the sweep, the withdrawal may be made from the NOW account 150 at 650 and the withdrawal record 240 incremented, at 635.

If the withdrawal record 240 is greater than the withdrawal limit 170 (i.e., the entire balance is currently held in the NOW account 150), the withdrawal transaction mechanism 230 may simply make a withdrawal from the NOW account 150 and the withdrawal record 240 is incremented at 635. When a new cycle starts, determined at 655, the BOP sweep mechanism 250 may sweep, at 660, the entire balance held in the NOW account 150 back to the MMDA 110 and then return to 615 to reset the withdrawal record 240 for the new cycle. If it is still within the same cycle, the process may return to 620 to handle the next net withdrawal request.

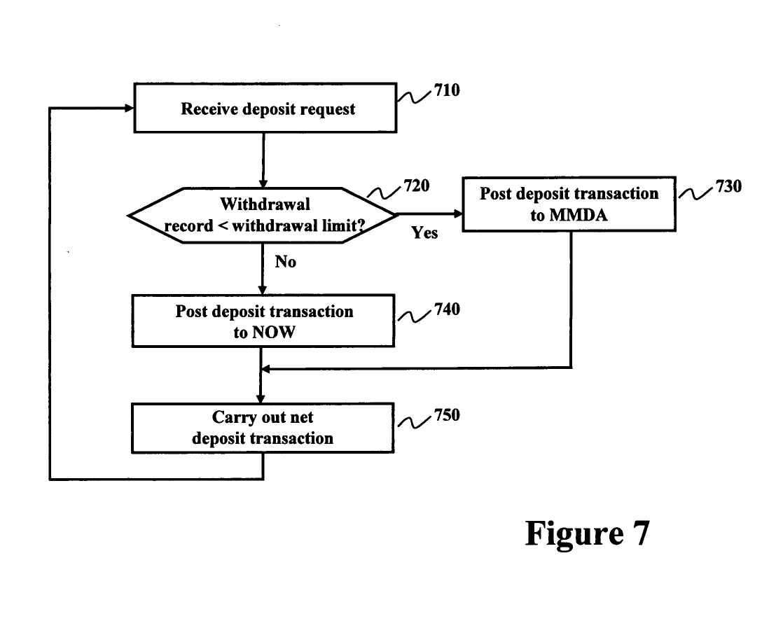

FIG. 7 is a flowchart of an exemplary process, in which net deposit transactions are carried out between two accounts, according to at least one embodiment of the present invention. A net deposit request (280) may be first received at 710. It may then be determined in which account the balance is currently held. As mentioned earlier, there may be different ways to implementation such determination. In this illustrative embodiment, to determine where the deposit should be made, the deposit transaction mechanism 260 (FIG. 2) may examine, at 720, whether the withdrawal record 240 is below the withdrawal limit 170. If the withdrawal record 240 is below the withdrawal limit 170, the balance may be currently held in the MMDA 110. In this case, the deposit transaction mechanism 260 posts, at 730, a deposit transaction with respect to the MMDA 110. This may include placing an order to buy certain mutual funds for the deposit amount (fractional share may apply). Otherwise, the deposit transaction mechanism 260 may post, at 740, a deposit transaction with respect to the NOW account 150. The posted net deposit transaction may be then carried out at 750 before the process returns to 710 to handle the next net deposit request.

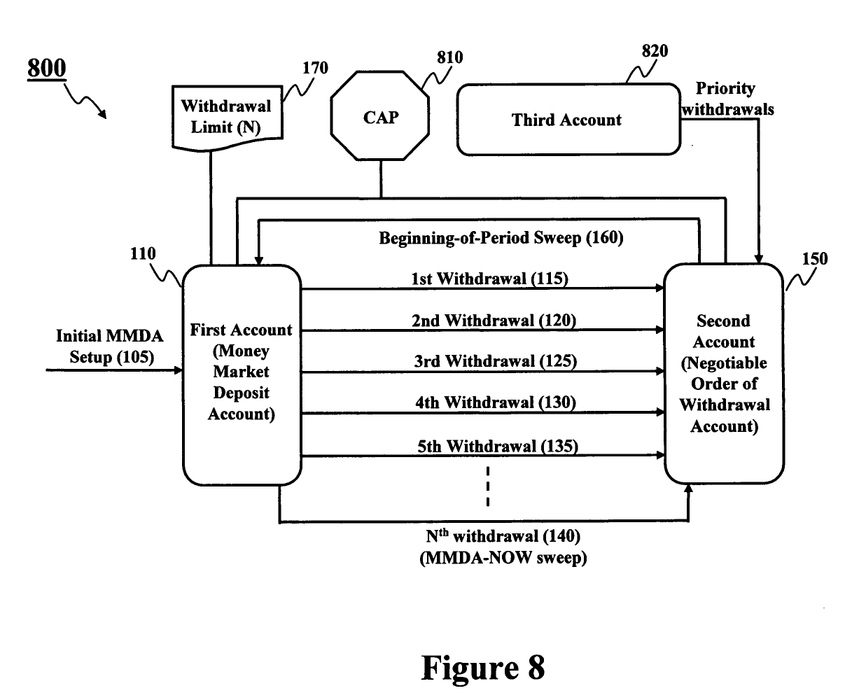

FIG. 8 describes a further embodiment of a sweep method 800. Similar to the sweep method 100, in such embodiments there may be a first account 110 (e.g., MMDA) and a second account 150 (e.g., NOW account). In this scheme, there may be a third account 820 involved. The first account or MMDA 110 may have a withdrawal limit 170 imposed according to regulations. Both the first and the second accounts may be insured (e.g., by FDIC) and there is a cap 810, applicable to both the MMDA 110 and the NOW account 150. That is, the total balance between the MMDA 110 and the NOW account 150 may be may be insured up to an amount specified by the cap 810. The third account 820 may be created to hold additional balance beyond the cap. That is, the third account 820 may be created to ensure that the total balance in the MMDA 110 and the NOW account 150 does not exceed the cap 810.

When the total balance (in the MMDA 110 and the NOW account 150) does not exceed the cap 810, a withdrawal may be made either from the MMDA 110 or from the NOW account, depending on the sweep method 100 described in FIG. 1. In this case, when a new cycle begins, the total balance is held in the MMDA 110 and a withdrawal record (recording the number of withdrawals in a current cycle) may be reset. When a first withdrawal (115) is requested, the withdrawal may be made from the MMDA 110 to the NOW account 150. The number of withdrawals may be incremented by one after the withdrawal. The same process may take place for the second withdrawal (120), the third (125), the fourth (130), the fifth (135). This may continue until a withdrawal that makes the cumulative number of withdrawals equal to the withdrawal limit 170 (N).

When the Nth withdrawal request within a current cycle is received, the total balance remaining in the MMDA 110 may be swept to the NOW account 150. This is an MMDA to NOW sweep (140). The N^{th} withdrawal may be then made from the NOW account 150 after the sweep. From this point on within the same cycle, all subsequent withdrawals may be made from the NOW account 150.

When a new cycle begins, the total balance remaining in the NOW account 150 may be swept back to the MMDA 110. This is so called NOW to MMDA sweep (160) or beginning-of-period sweep. During this beginning of the period sweep, the withdrawal record may be reset for the new cycle.

When the total balance exceeds the cap 810, part of the total balance may be swept to the third account 820 so that the remaining balance in the MMDA 110 and the NOW account 150 does not go over the cap 810. The third account 820 may not be insured and there may not be a limit on the number of withdrawals during each cycle. However, there may be some limitations associated with the third account 820. For example, a minimum balance may be required.

When there is fund available in the third account 820, withdrawals may be carried out first from the third account 820. Such withdrawals may take priority over the withdrawals from either the MMDA 110 or the NOW account 150. In this case, when a withdrawal request is received, it may be examined first to see whether there is any fund available in the third account 820. If there is, the withdrawal may be made from there. If the fund in the third account 820 can cover only part of the requested withdrawal amount, part of the withdrawal may be made from the third account 820 and remaining of the withdrawal may be made from either the MMDA 110 or the NOW account 150. In these embodiments, only when there is no fund available at all in the third account 820, the withdrawal may be made according to the scheme described in FIG. 1.

The third account 820 may be set up according to the choice of the client associated with the underlying MMDA 110 and the NOW account 150. The client may specify not only whether a third account is to be set up to facilitate the above mentioned sweep method but also how the third account is to be operated. For example, the client may specify how the money moved into the third account 820 is to be invested (e.g., what mutual fund(s) to buy). Similar to previous discussion related to sweep operation, fund movement in and out of the third account 820 may involve different operations depending on how the involved accounts are set up. For instance, the third account 820 may be set up as a simple cash account, the MMDA 110 may be set up as an account holding balance in a primary fund (e.g., a particular mutual fund), and the NOW account 150 may be set up also as a cash account. In this case, if money is moved from the MMDA 110 to the third account 820, it may be required to sell some shares of the mutual fund from the MMDA 110 first to obtain cash, which is then moved to the third account 820. If money is moved from the NOW account 150 to the third account 820, only simple cash transfer may be required.

If the third account 820 is set up to hold balance in a different fund (secondary fund), then any amount of money moved into the third account 820 may need to be provided in terms of shares of the secondary fund valued at the amount to be moved in. Similarly, any money amount to be withdrawn from the third account may be required to be cash so that a sale has to occur first. If money is moved in from the MMDA 110 that holds primary funds, then both sale (i.e., sell certain shares of the primary fund) and purchase (i.e., buy certain shares of the secondary fund) may take place.

When a client has opted not to have the third account 820, the sweep method 800 may operate in a manner similar to the sweep method 100 described in FIG. 1.

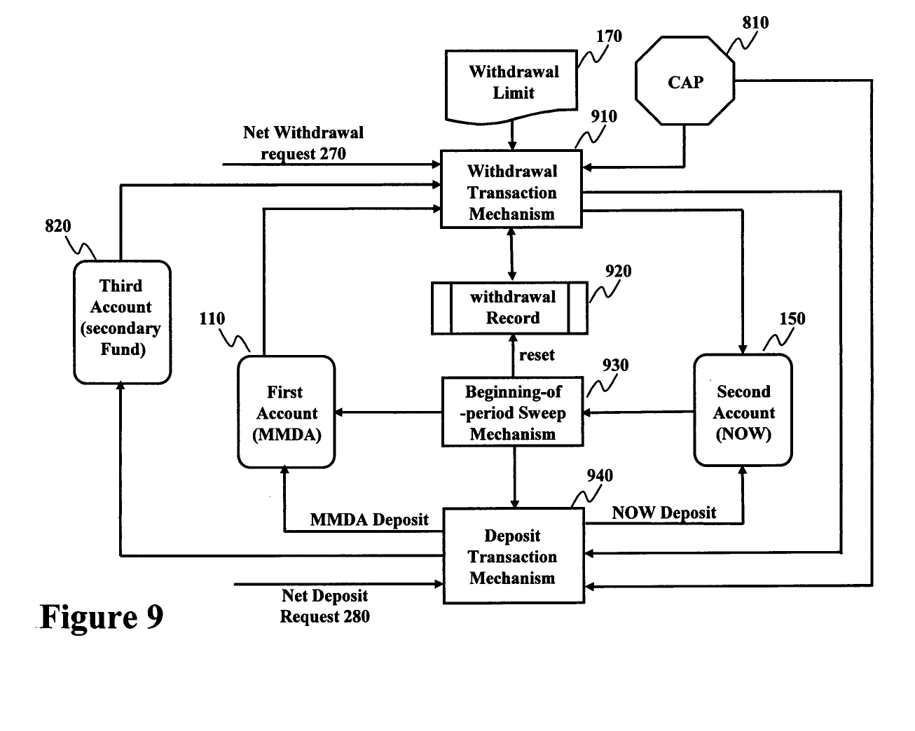

FIG. 9 depicts an exemplary system 900 that may facilitate transaction activities between different accounts in compliance with the sweep method 800, according to an embodiment of the present invention. The system 900 may comprise the three accounts, namely the first account (MMDA) 110, the second (NOW) account 150, and the third account 820, a withdrawal transaction mechanism 910, a withdrawal record 920, a beginning-of-period (BOP) sweep mechanism 930, and a deposit transaction mechanism 940.

Due to the presence of the third account 820, mechanisms in the system 900 may function differently than the corresponding mechanisms in system 200 (FIG. 2). The operations to be performed to each withdrawal or deposit request may be determined according to various criteria. For example, both the existing limits such as the withdrawal limit 170 and the cap 810 should be observed. In addition, the current status of all three accounts also should be observed in order to determine the correct operations as described above, e.g., both the withdrawal transaction mechanism 910 and the deposit transaction mechanism 940 may determine first whether a withdrawal/deposit is to be carried out with respect to the third account 820.

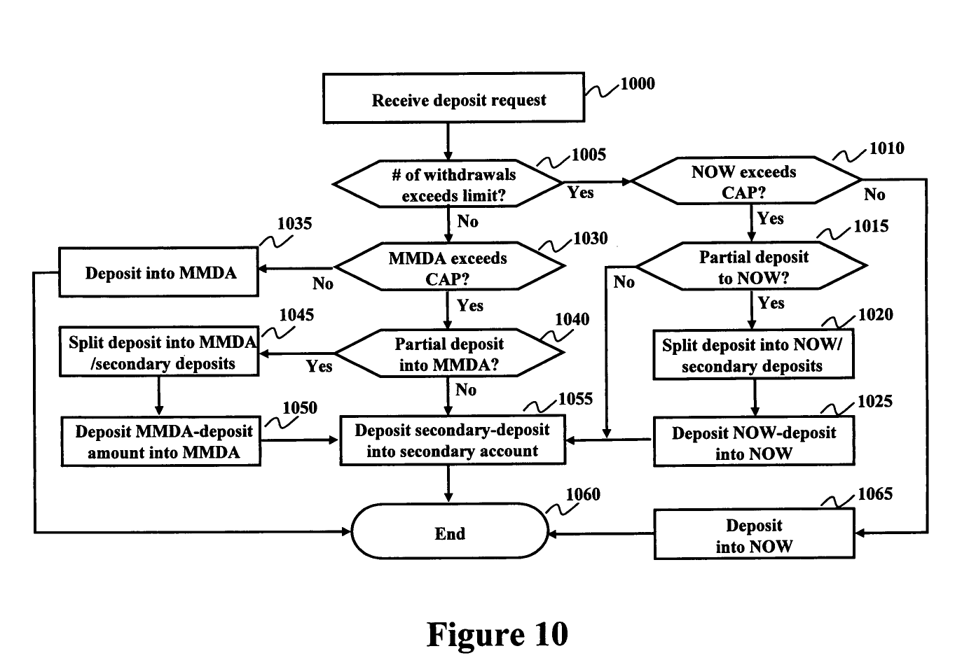

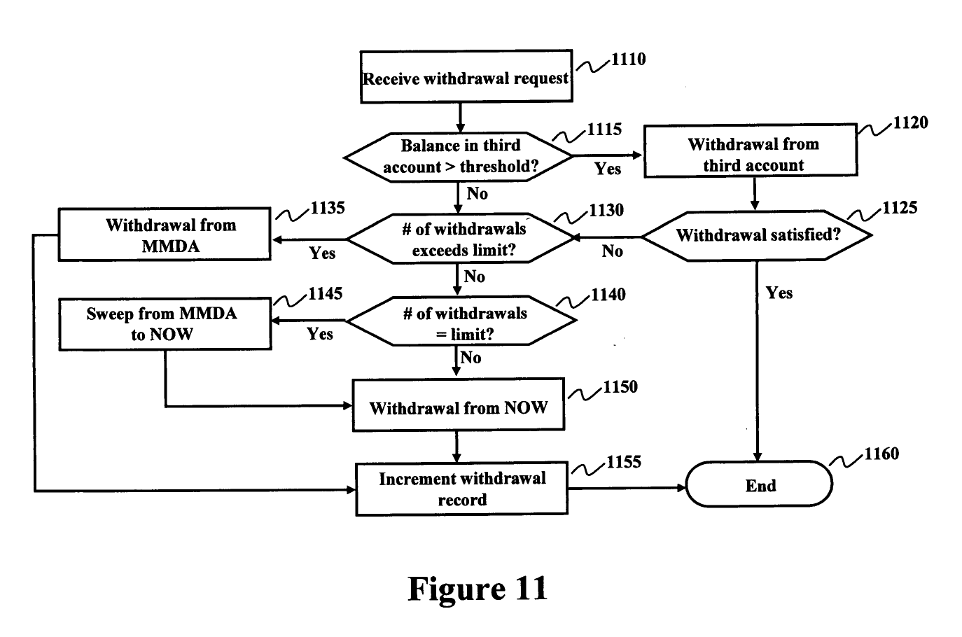

Furthermore, other peripheral operations may also need to be performed differently. For instance, when the withdrawal transaction mechanism 910 determines to make a withdrawal from the third account 820, the withdrawal record 920 may not need to be incremented. Further details related to how the deposit transaction mechanism 940 operates are discussed with reference to FIG. 10 herein. Further details related to how the withdrawal transaction mechanism 910 operates are discussed with reference to FIG. 11 herein.

FIG. 10 is a flowchart of an exemplary process, in which the deposit transaction mechanism 940 may facilitate net deposit transactions within the constraints of the cap 810 on insured amount and the withdrawal limit 170 on number of withdrawals, according to an embodiment of the present invention. A deposit request may be first received at 1000. As mentioned earlier, a transaction request may correspond to either an individual or single actual transaction request or a net transaction aggregated over a pre-determined time frame.

Upon receiving the deposit request, the deposit transaction mechanism 940 may determine where the total balance in the MMDA 110 and the NOW account 150 is currently held. As pointed out earlier, there may be different means to make this determination. Examples include a flag or the withdrawal record 920, which is described here as an illustration. If the recorded number of withdrawals (the withdrawal record 920) in the current cycle exceeds the withdrawal limit 170, determined at 1005, the total balance may be currently held in the NOW account 150. Otherwise, the total balance is currently in the MMDA 110.

If the total balance is in the NOW account 150, it may be further examined, at 1010, whether the sum of the total balance and the deposit amount exceeds the cap 810. If the sum does not exceed the cap 810, the deposit transaction mechanism 940 may simply deposit, at 1065, into the NOW account 150 before the process ends at 1060.

If the sum of the total balance and the deposit amount exceeds the cap 810, it may be further determined, at 1015, whether any amount of deposit can be deposited into the NOW account 150. This determination is true when the total balance in the NOW account 150 does not reach the cap 810 prior to the deposit. If the total balance already reaches the cap 810 before the deposit, then the entire deposit may be deposited, at 1055, into the third account 820.

When the total balance before deposit does not reach the cap 810, the total amount for deposit may be split, at 1020, into two portions: a NOW-deposit amount corresponding to the amount to be deposited into the NOW account 150 so that the sum of the total balance and the NOW-deposit amount adds up to the cap 810 and a secondary-deposit amount to be deposited into the third account 820. The deposit transaction mechanism 940 may then deposit, at 1025, the NOW-deposit amount into the NOW account 150 and deposit, at 1055, the secondary-deposit amount into the third account 820.

If the total balance is currently held in the MMDA 110, determined at 1005, the deposit transaction mechanism 940 may go through a similar determination process with respect to the MMDA 110. It may be first examined, at 1030, whether the sum of the total balance and the deposit amount exceeds the cap 810. If the sum does not exceed the cap 810, the deposit transaction mechanism 940 may simply deposit, at 1035, into the MMDA 110 before the process ends at 1060.

If the sum of the total balance in the MMDA 110 and the deposit amount exceeds the cap 810, it may be further determined, at 1040, whether any amount of deposit can be deposited into the MMDA 110. If the total balance already reaches the cap 810 before the deposit, then the entire deposit amount may be deposited, at 1055, into the third account 820.

If the total balance before deposit does not reach the cap 810, the total amount for deposit is split, at 1045, into two portions: an MMDA-deposit amount corresponding to the amount to be deposited into the MMDA 110 so that the sum of the total balance and the MMDA-deposit amount adds up to the cap 810, and a secondary-deposit amount to be deposited into the third account 820. The deposit transaction mechanism 940 may then deposit, at 1050, the MMDA-deposit amount into the MMDA 110 and deposit, at 1055, the secondary-deposit amount into the third account 820.

Other alternative solutions to carry out a deposit transaction may also be employed. For example, the strategy of partial deposit into both the third account 820 and another account (either the MMDA 110 or the NOW account 150) may not be allowed. Alternatively, if the sum of the total balance and the deposit amount exceeds the cap 810, the entire deposit may be made directly in the third account 820 instead of carrying out two partial deposits. The flow shown in FIG. 10 is merely an illustration and does not limit the solutions that may be adopted in achieving a deposit scheme in which both the withdrawal limit 170 and the cap 810 are observed and enforced.

FIG. 11 is a flowchart of an exemplary process, in which the withdrawal transaction mechanism 910 may facilitate net withdrawal transactions within the constraints of the cap 810 and the withdrawal limit 170, according to an embodiment of the present invention. A withdrawal request may be first received at 1110. Similar to a deposit request, the withdrawal request may correspond to a single transaction request or a net transaction aggregated over a predetermined time frame.

To determine where the withdrawal is to be made, the withdrawal transaction mechanism 910 may examine, at 1115, whether there is a positive balance in the third account 820 that exceeds a threshold. This threshold may correspond to a minimum balance requirement. If the balance in the third account exceeds the threshold, the withdrawal transaction mechanism 910 may withdraw, at 1120, from the third account 820. There may be several scenarios after the withdrawal from the third account 820. The first scenario may be that the entire withdrawal can be made from the third account 820, determined at 1125. In this case, the process ends at 1160 without incrementing the withdrawal record 920.

If only partial withdrawal can be made from the third account 820, the withdrawal transaction mechanism 910 may further determine from where (either the MMDA 110 or the NOW account 150) the remaining amount is to be withdrawn. This may be the same determination process as in the scenario in which the withdrawal cannot be made from the third account 820 at all (i.e., the third account 820 does not have a balance above the threshold, determined at 1115). The difference may be the amount of withdrawal to be made from either the MMDA 110 or the NOW account 150. In the former case, it may be the remaining amount after a partial withdrawal is made from the third account 820. In the latter case, it may be the entire withdrawal amount specified in the withdrawal request.

To determine where to make the withdrawal, the withdrawal transaction mechanism 910 may first determine, at 1130, whether the accumulated number of withdrawals in the current cycle (indicated by the withdrawal record 920) exceeds the withdrawal limit 170. If the number of withdrawals so far conducted is still below the withdrawal limit 170, this indicates that the total balance is still held in the MMDA 110. In this case, the withdrawal transaction mechanism 910 may withdraw, at 1135, from the MMDA 110 and then increment, at 1155, the withdrawal record 920 before it ends the process at 1060.

If the accumulated number of withdrawals in the current cycle is not below the withdrawal limit 170, it may be further examined, at 1140, whether the number of withdrawals equals to the withdrawal limit 170. If so, the withdrawal transaction mechanism 910 may first sweep the entire balance from the MMDA 110 to the NOW account 150 and then make the withdrawal from the NOW account 150 at 1150. If the number of withdrawals exceeds the withdrawal limit 170, it may mean that the entire balance is currently held in the NOW account 150. In this case, the withdrawal transaction mechanism 910 may simply withdraw, at 1150, from the NOW account 150. Then, the withdrawal record 920 may be incremented at 1155 before the process ends at 1160.

Other alternative solutions to carry out a withdrawal may also be employed. For example, partial withdrawal from the third account 820 may not be adopted. In this case, if the balance in the third account 820 is not enough the satisfy the entire withdrawal amount, the withdrawal transaction mechanism 910 may simply carry the withdrawal from either the MMDA 110 or the NOW account 150. The flow shown in FIG. 11 is merely an illustration and does not limit the solutions that may be adopted in achieving a withdrawal and sweep method in which both the withdrawal limit 170 and the cap 810 may be observed and enforced.

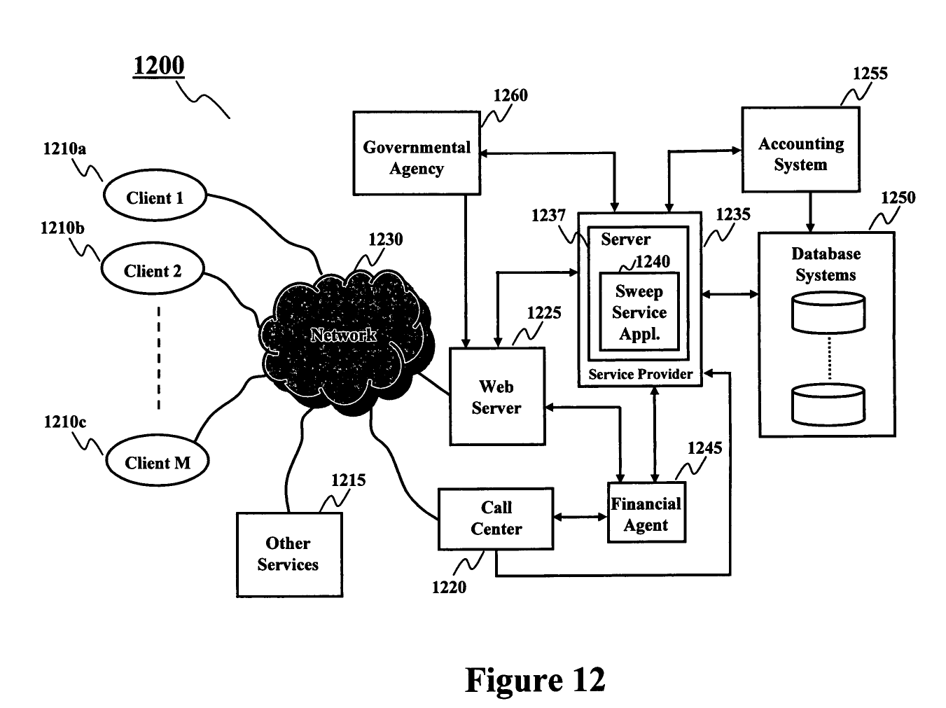

FIG. 12 depicts an exemplary framework 1200 in which a sweep service 1240 may be offered, according to at least one embodiment of the present invention. In the framework 1200, a service provider 1235 offers a sweep service to a plurality of clients (e.g., client 1 1210a, client 2 1210b, . . . , client M 1210c) from a server 1237 via a network 1230. The sweep service may be offered through a sweep service application 1240 running on the server 1237 and the sweep service may be offered in accordance with one or more sweep method that is consistent with what is described above (e.g., the sweep methods 100 and 800) or a combination thereof.

The network 1230 may represent a generic network, which may correspond to a local area network (LAN), a wide area network (WAN), the Internet, a proprietary network, a telephone network, a wireless network, or a conventional postal mail network. Depending on the nature of the network employed for a particular application, the network 1230 may be implemented accordingly. The network 1230 serves the purpose of delivering information between connected parties.

The service provider 1235 may correspond to a bank, an investment institution, or other organization or company that offers financial services. The service provider 1235 may offer other services as well in addition to the sweep service. For example, an investment institution may offer banking services in addition to its investment services. In the sweep methods described earlier, the sweep operations may interface with different investment services and carry out transactions in the context of investment accounts that hold balance as, for example, mutual funds. The sweep operations may also interface with conventional banking accounts with cash transactions.

The service provider 1235 may include a server 1237 which may be connected to different parties for different needs or purposes via different means. For example, the service provider 1235 may interact with its clients through an online web site supported by a web server 1225 (for example, a Netscape™ web server), its representatives such as a financial agent 1245 who interacts with the clients via calls routed from a call center 1220, or directly via the call center 1220 that forwards a transaction request from a client through its automatic call routing.

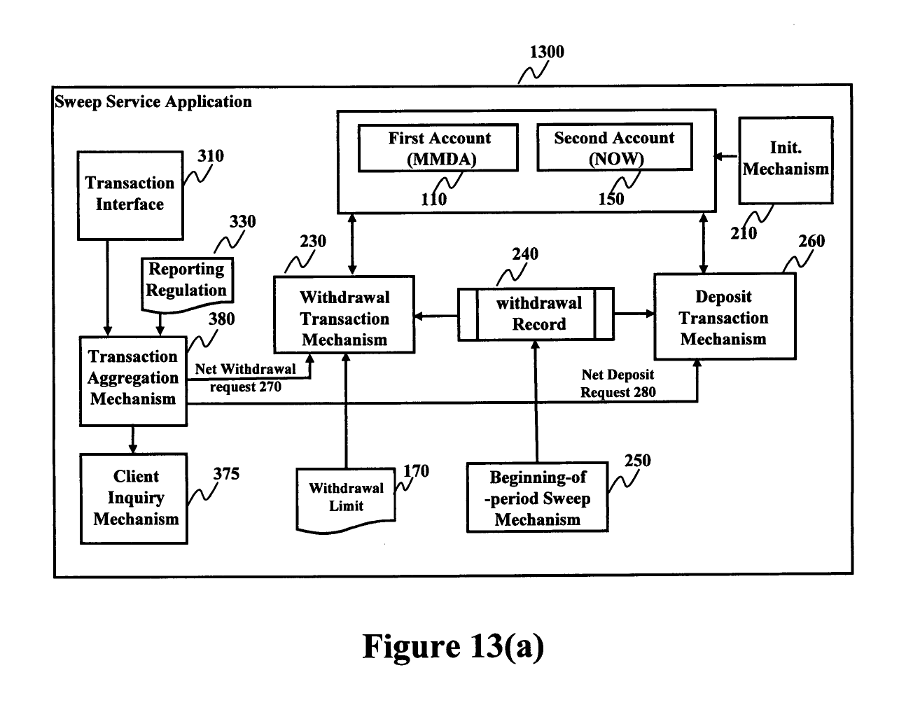

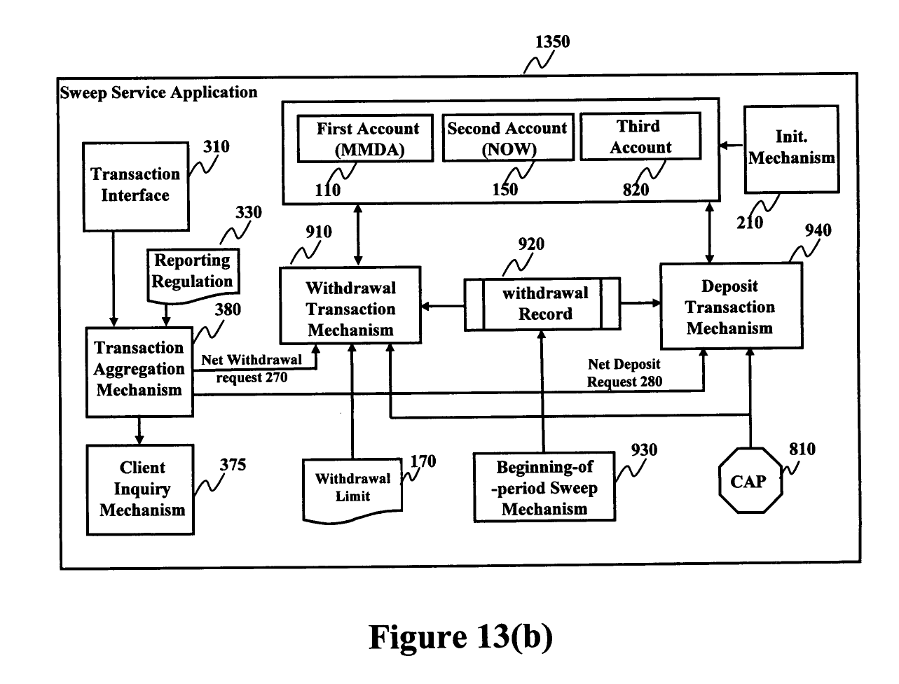

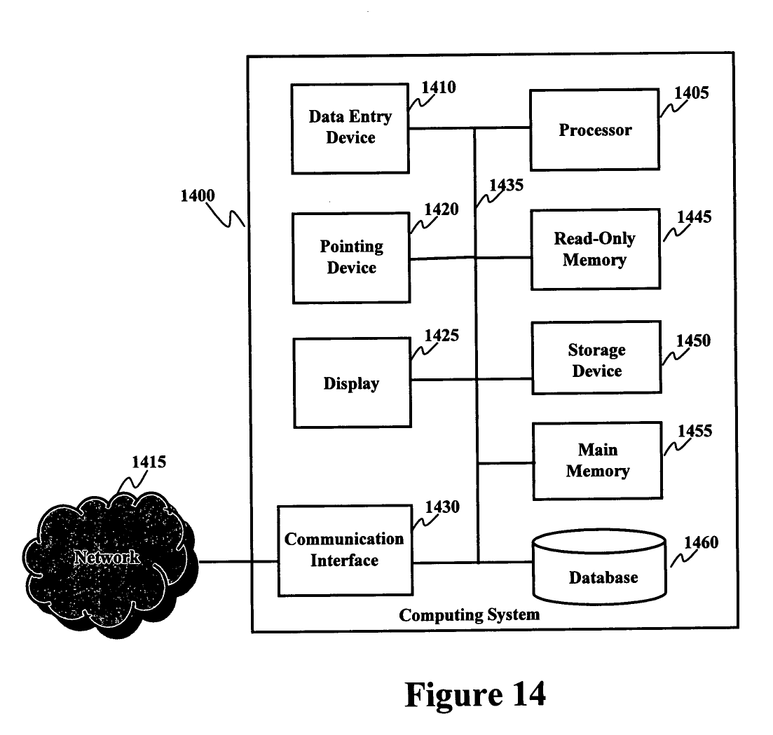

FIGS. 13(a) and 13(b) are block diagrams showing portions of at least one embodiment of a sweep service application 1240. The server 1237 may include the sweep service application 1300. The sweep service application 1240 may include a sequence of programmed instructions which, upon execution, are operable to configure a computer system 1400 (shown in FIG. 14) to carry out the client funds management operations described herein. These software instructions may be implemented using, for example, Javascript® instructions. Other implementations are possible. For example, portion of the sweep service application 1240 may be implemented using programmed instructions in accordance with the C++, Visual Basic™, or Javascript® programming languages, or any combination thereof. The server 1237 may thereby be configured, using a sequence of programming instructions, for example, to perform sweeping operations as described herein. The sweep service application 1240 may also include sequences of database access scripts to effect storage and retrieval of data using the database 1250. These database access scripts may be implemented in the form of SQL scripts.

Referring to FIG. 13(a), one embodiment of the sweep service application (e.g., 1300) may include one or more modules or mechanisms including sequences of programmed instructions which cooperate to perform client funds management operations. In particular, in at least one embodiment, the sweep service application 1300 may include an initialization mechanism 210, a withdrawal transaction mechanism 230, a withdrawal record 240, a beginning-of-period sweep mechanism 250, a deposit transaction mechanism 260, a transaction interface 310, a transaction aggregation mechanism 380, and a client inquiry mechanism 375. As shown in FIG. 3, an embodiment of the transaction aggregation mechanism 380 may further include an account activity posting mechanism 320, an account activity record 325, an account activity reporting mechanism 335, a transaction buffering mechanism 345, a transaction buffer 350, a timer 355, an aggregation mechanism 365, a net transactions record 370, a transaction request retrieval mechanism 410, a sorting mechanism 420. Furthermore, the aggregation mechanism 365 may include, as shown in FIG. 4, a withdrawal transaction aggregation mechanism 430, a deposit transaction aggregation mechanism 440, a net transaction determiner 450 and a net transaction recording mechanism 460. These modules may cooperate to achieve client funds management operations as described with respect to FIGS. 1-7 herein, for example.

Referring to FIG. 13(b), another embodiment of the sweep service application (e.g., 1350) may include one or more modules or mechanisms including sequences of programmed instructions which cooperate to perform client funds management operations. In particular, in at least one embodiment, the sweep service application 1350 may include an initialization mechanism 210, a withdrawal transaction mechanism 910, a withdrawal record 920, a beginning-of-period sweep mechanism 930, a deposit transaction mechanism 940, a transaction interface 310, a transaction aggregation mechanism 380, and a client inquiry mechanism 375. Similarly, as shown in FIG. 3, one embodiment of the transaction aggregation mechanism 380 may include an account activity posting mechanism 320, an account activity record 325, an account activity reporting mechanism 335, a transaction buffering mechanism 345, a transaction buffer 350, a timer 355, an aggregation mechanism 365, a net transactions record 370, a transaction request retrieval mechanism 410, a sorting mechanism 420. Furthermore, the aggregation mechanism 365 may include, as shown in FIG. 4, a withdrawal transaction aggregation mechanism 430, a deposit transaction aggregation mechanism 440, a net transaction determiner 450 and a net transaction recording mechanism 460. These modules may cooperate to achieve client funds management operations as described with respect to FIGS. 8-11 herein, for example.

At least one embodiment of the present invention relates to the use of the computer system 1400 for client funds management using a server 1237. FIG. 14 is a block diagram of a computer system 1400 that may be used in some embodiments to implement the computing platform for the server 1237. The computing system 1400 may be implemented as or include one or more personal computers, workstations, handheld personal data assistants, Internet appliances (e.g., a computer with minimal memory, disk storage and processing power designed to connect to a network, especially the Internet, etc.), or controllers. The computer system 1400 may include a bus 1435 or other communication mechanism for communicating information, and a processor 1405 coupled with the bus 1435 for processing information. The computer system 1400 also may include a main memory 1455, such as a Random Access Memory (RAM) or other dynamic storage device, coupled to the bus 1400 for storing information and instructions to be executed by the processor 1405. The main memory 1455 also may be used for storing temporary variable or other intermediate information during execution of instructions to be executed by the processor 1405.

The computer system 1400 further may include a Read-Only Memory (ROM) 1445 or other static storage device coupled to the bus 1435 for storing static information and instructions for the processor 1405. A storage device 1450, such as a magnetic disk or optical disk, may be provided and coupled to the bus 1435 for storing information and instructions.

The processor 1405 may fetch the instructions, decode them, and act or instruct other elements 1410-1460 to, for example, transfer data to or from the memory 1455 or to work in combination with the data entry device 1410 or the display 1425 (for example, to input or output data), etc. The processor 1405 may actually be implemented as more than one processor. It should be appreciated that the processor 1405 may be implemented as a general purpose microprocessor, for example, in a central processing unit, a microcontroller, or other similar device.

A database 1460 may be coupled to the bus 1435 for storing static information and software instructions. Information stored in or maintained using the database 1460 may be provided in conformance with a database management system format such as, but not limited to, the SQL format. The database 1460 may be a SQL database provided by the Oracle® Corporation of Redwood Shores, Calif. Alternatively, the database 1460 may be a SQL Server 7.0 database supporting the ADO and ODBC protocols provided by IBM® Corporation or Sybase® Corporation. The database 1460 may include information including, but not limited to, database query and access instructions in the form of one or more scripts which, when executed by a processor such as the processor 1405, serve to store and retrieve data maintained using the database 1460 according to the instructions contained in the script, and in particular regarding the data fields to be accessed, as well as their arrangement, provided in the response to the processor 1405.

According to at least one embodiment of the present invention, sweep related operations as described herein may be provided by the computer system 1400 in response to the processor 1405 executing one or more sequences of instructions contained in the main memory 1455. Such instructions may be read into the main memory 1455 from another computer-readable medium, such as the storage device 1450 or the database 1460. Execution of the sequences of instructions contained in the main memory 1455 may cause the processor 1405 to perform the process steps described herein. One or more processors in a multi-processing arrangement may also be employed to execute the sequences of instructions contained in the main memory 1455. Alternatively, hard-wired circuitry may be used in place of or in combination with software instructions to implement the invention. Thus, embodiments of the invention are not limited to any specific combination of hardware circuitry and software.

The computer system 1400 may be coupled via the bus 1435 to a display 1425 for outputting information to a computer user. In one embodiment, the display 1425 may be a Cathode Ray Tube (CRT) computer display monitor capable of displaying information using multiple colors. Alternatively, the display 1425 may be a liquid crystal display, a monochrome monitor, a web-enabled wireless terminal or handheld terminal such as, for example, a Personal Digital Assistant (PDA). The computer system 1400 may include other output devices as well such as, but not limited to, a printer.

A data entry device 1415, including alphanumeric and other keys, may be coupled to the bus 1435 for communicating information and command selections to the processor 1405. Another type of user input device which may be coupled to the bus 1435 is a pointing device 1420, which may be a computer mouse, trackball, cursor direction keypad, tactile directional fingerpad, or other such device for allowing a user to control cursor location and movement on the display 1425, and for communicating direction information and command selections to the processor 1405. This pointing device 1420 typically has two degrees of freedom in two axes, a first axis (e.g., x) and a second axis (e.g., y), that allows the pointing device to specify positions in a plane.

The term “computer-readable medium” as used herein refers to any medium that participates in providing instructions to the processor 1405 for execution. Such a medium may take many forms, including, but not limited to, non-volatile media, volatile media, and transmission media. Non-volatile media include, for example, optical or magnetic disks, such as the storage device 1450. Volatile media include dynamic memory, such as the main memory 1455. Transmission media can also take the form of acoustic or light waves, such as those generated during Radio Frequency (RF) and InfraRed (IR) communications. Common forms of computer-readable media include, for example, floppy disk, a flexible disk, hard disk, magnetic tape, any other magnetic medium, a Compact Disc Read Only Memory (CD ROM), Digital Video Disc (DVD) or any other optical medium, punch cards, paper tape, any other physical medium with patterns of holes, a Random Access Memory (RAM), a Programmable Read Only Memory (PROM), an Erasable Programmable Read Only Memory (EPROM), a Flash EPROM, any other memory chip or cartridge, a carrier wave as described hereinafter, or any other medium from which a computer can read.

Various forms of computer-readable media may be involved in carrying one or more sequences of one or more instructions to the processor 1405 for execution. For example, the instructions may initially be borne on a magnetic disk of a remote computer. The remote computer may load the instruction into its dynamic memory and send the instructions over a telephone line using a modem. A modem local to the computer system 1400 may receive the data on the telephone line and use an infrared transmitter to convert the data to an infrared signal and place the data on the bus 1435. The bus 1435 may carry the data to the main memory 1455, from which the processor 1405 retrieves and executes the instructions. The instructions received by the main memory 1455 may optionally be stored on the storage device 1450 either before or after execution by the processor 1405.

The computer system 1400 may also include a communication interface 1430 coupled to the bus 1435. The communication interface 1430 may provide a two-way data communication coupling to the network 1415. For example, the communication interface 1430 may be a modem or an Integrated Services Digital Network (ISDN) card to provide a data communication connection to a corresponding type of telephone line. As another example, the communication interface 1430 may be a LAN card to provide a data communication connection to a compatible LAN. Wireless links may also be implemented. In any such implementation, the communication interface 1430 sends and receives electrical, electromagnetic, or optical signals that carry digital data streams representing various types of information.

The communication interface 1430 may provide data communication through one or more networks to other data devices. For example, the communication interface 1430 may provide a connection through a local network to a host computer or to data equipment operated by an Internet Service Provider (ISP). The ISP may in turn provide data communication services through a worldwide packet data communication network such as the Internet. These networks use electrical, electromagnetic, or optical signals that carry digital data streams. These signals are exemplary forms of carrier waves transporting the information.

The communications interface 1430 may include an Ethernet interface or a LAN communication card, a dial-up modem interface using the PSTN, an intranet, or any combination thereof.

The computer system 1400 may send messages and receive data, including program codes, through the network(s) and the communication interface 1430. In the Internet example, a server might transmit a requested code for an application program through the Internet, ISP, and the communication interface 1430. One such downloaded application may, for example, provide for fund sweep as described herein. The received code may be executed by the processor 1405 as it is received, and/or stored in the storage device 1450, or other non-volatile storage for later execution. In this manner, the computer system 1400 may obtain an application code in the form of a carrier wave.

The server 1237 may receive commands and data from the clients terminals (e.g., 1210a) and output program code and data to the client terminals 105 using the network 1415. In an embodiment, the server 1237 may generate and transmit the requested information to the requesting user via Hypertext Transfer Markup Language (HTML) formatted or eXtensible Markup Language (XML) formatted pages, which may be provided as World Wide Web pages, using the network 1415. As described previously, the network 1415 may be, for example, a network of interconnected networks such as the Internet, a LAN, a WAN, an intranet including any of these, and/or the PSTN. Interactive pages transmitted and received using the network 1415 may conform to the SSL protocol.

The communications interface 1430 may further include a web browser or a so-called thin client. A thin client may be a client portion of an application designed to require little memory so that the bulk of the data processing occurs on a corresponding server. In at least one embodiment, a thin client may be Java-based. The web browser displays data and is capable of communicating with other computers via a network such as, for example, the Internet or an intranet. The web browser provides a user with a way to navigate, via, for example, hyperlinks which are selected by the pointing device 1420 such as a computer mouse, or as typed in by the user. The web browser uses a protocol such as, for example, HyperText Transfer Protocol (HTTP) or File Transfer Protocol (FTP), to transmit data of various content such as, for example, HTML formatted documents, plain text documents, graphic images, and XML documents for presentation to the user via the display 1425. Web pages formatted in accordance with HTML or XML may also be provided in accordance with the eXtensible Style Language (XSL) specification available from the World Wide Web Consortium. XSL is useful for separating style from content as well as for providing a common interface for sharing of web pages across applications. The web browser may also run or execute programs, such as Java applets including sequences of instructions provided in accordance with the Java programming language, or JavaScript. The web browser may be, for example, Internet Explorer® by Microsoft® Corporation, Netscape Navigator® by Netscape®, America Online® browser, or any other web browser. A thin client may utilize a two or more tiered client server model. In this model, the may client run a minimal set of services that provide functionality to interface with at least one server. A web browser may be a thin client. The server 1237 may run, for example, the Windows® NT network operating system available from Microsoft® Corporation of Redmond, Wash.

Instructions executed by the processor 1405 from the main memory 1455 may include, for example, application software instructions that cause the processor 1405 to perform operations as described herein. These application instructions may be implemented in the form of source code statements provided in accordance with, for example, the Visual C++® and Visual Basic® higher order programming languages, development kits for which are available from Microsoft® Corporation of Redmond, Wash. Application instructions may also include database scripts for accessing, storing, or selectively retrieving information contained in the database 1460. The database scripts may be contained in the storage device 1450 or may be stored using the database 1460. The database scripts may be implemented in the form of programming statements provided in accordance with, for example, SQL version 7.0 database management system query language, as well as the IBM DB2® system. Other database implementations are possible, including those available from Oracle® or Transact SQL in accordance with the ColdFusion® database management system.

Application software instructions may include a user interface portion, which may be a Graphical User Interface (GUI) portion, for generating interactive pages or display screens by which a user may provide data to and receive information from the computer system 1400 and the database 1460 using a human-machine interface such as, but not limited to, the display 1425. Interactive pages may include user dialog boxes for accepting user entered information. In particular, the GUI portion may prompt the user to enter data by providing an interactive dialog box or message box instructing the user to enter particular data, or to select from among a multitude of options provided using a pull-down menu. The human-machine interface may also include a hardcopy generating device such as a printer. A user may interact with the computer system 1400 via the graphical user interface provided by the GUI portion by using the pointing device 1420 and the data entry device 1410. The GUI portion may place the output of the computer system 1400 in a format for presentation to a user via the display 1425. In at least one embodiment, the GUI may be implemented as a sequence of Java instructions such as, for example, Java Swing® instructions. Java Swing® is part of the Java™ Foundation Classes (JFC) in the Java™ platform. The JFC encompasses a group of features to aid in the development of GUIs. Swing® provides all the components from buttons to split panes and tables. The Java™ classes and logic of the GUI may be implemented in Java™.

In particular, a user may select a particular data entry field of an interactive display page presented using the display 1425 by using the pointing device 1420 or the data entry device 1410 to select that field. Upon selecting a field, a user may then enter information into the data entry field using the data entry device 1410. After the user has entered data into the data entry field, the user may cause the GUI portion to input the user-entered information to the computer system 1400 using the pointing device 1420 to select a corresponding display icon or command button.

Thus, a client terminal (e.g., 1210a) may send messages and receive data through the network(s) 1415 and the communications interface 1430. In at least one embodiment, a client terminal might transmit a requested code for an application program through the Internet, ISP, and/or the communication interface. In accordance with at least one embodiment, one such downloaded application provides for user interaction with the sweeping service application (e.g., 1300 or 1350) using the interactive displays or interactive pages described herein. The received code may be executed by the processor 1405 as it is received, and/or stored in a non-volatile storage device for later execution. In this manner, computer system 1400 may obtain an application code in the form of a carrier wave.

The server 1237 may receive commands and data from the client terminals 1210 and output program code and data to the terminals 1210 using the network 1415. In at least one embodiment, the server 1237 may generate and transmit the requested data to the requesting user via HTML formatted or XML formatted pages, which may be provided as World Wide Web pages, using the network 1415. The network 1415 may be, for example, a network of interconnected networks such as the Internet, a LAN, a WAN, an intranet including any of these, and/or a PSTN. The communications interface 1430 may further include a web browser or thin client. A thin client is a client portion of an application designed to require little memory so that the bulk of the data processing occurs on a corresponding server. In at least one embodiment, a thin client may be Java-based. The web browser may be configured to display data and communicate with other computers via a network such as, for example, the Internet or an intranet. The web browser may provide a user with a way to navigate, via, for example, hyperlinks which may be selected by the pointing device (such as a computer mouse), or as typed in by the user. The web browser uses a protocol such as, for example, HyperText Transfer Protocol (HTTP) or File Transfer Protocol (FTP), to transmit data of various content such as, for example, HTML formatted documents, plain text documents, graphic images, and XML documents for output presentation to the user via the display.

Referring to FIG. 12, the web server 1225 may be configured to generate and output interactive pages to a user station using the World Wide Web and suitable for display using a web browser. The server 1237 may correspond to a secure web application server behind the web server 1225 that the service provider employs to run one or more web based application programs (e.g., an application program to carry out the sweep methods described above) in a secure fashion. Such a secure web application server may be configured to execute one or more web based application programs, responsive to commands and data received from the clients (via a web page supported by the web server 1225), and providing data and results to the clients. The web server 1225 and the web application server may be implemented using a single computing platform. Alternatively, they may also be implemented using separate computing platforms.

The service provider 1235 may also interact with other service providers 1215. Those other service providers may provide some form of support to the service provider 1235 to sustain its services. For example, the service provider 1235 may outsource its billing function to an outside company. Such billing function may include generate monthly statements with respect to individual accounts and send such statements to the home addresses of the account holders.

To support its services, including the sweep service 1240, the service provider 1235 may also communicate with different backend support mechanisms such as an accounting system 1255 and database systems 1250. The accounting system perform accounting related functionalities such as computing the gains associated with different accounts. For example, for investment accounts, the gain may be computed daily according to the market. For a cash account, the gain may be computed as accrual interest according to a dynamic interest rate of each individual account. Such computed gains are then deposited back into corresponding accounts or invested according to some pre-specified manner. The accounting system 1255 may be connected to the database systems 1250 in order to access relevant data stored.

The service provider 1235 may also perform some functions in compliance with laws or certain governmental regulations. The service provider 1235 may be in communication with some governmental agencies 1260 to synchronize its service with requirements. For example, the withdrawal limit 170, which restricts the total number of withdrawals allowed within a predetermined period, and the cap 810, which specifies the upper limit of the insured amount may be directly related to specific governmental regulations. As another example, the service provider may be required by regulation to report to the federal government on detailed transaction activities performed on the accounts to which it serves.

Functionalities performed in compliance with governmental regulations may be performed via a proprietary interface between the service provider 1235 or a secure web interface supported by the web server 1225. Such functionalities may be implemented as web based application programs executed on one or more secure web application servers.

The services offered by the service provider 1235, including the sweep service 1240, may be distributed (not shown). Different offices or locations that support the various services may manage their own local accounts on their local secure environment. The management at different locations may differ in terms of service policies. Although the management may be distributed, the service provider 1235 may have access to individual offices for management purposes through, for example, secure communication channels. Alternatively, there may be a centralized management of all distributed sites so that services supported at distributed sites may be controlled in a synchronous fashion.

The database systems 1250 may be responsible for providing data storage and data access, including retrieval, update, and deletion. The service provider 1235 may communicate with the database system 1250 in a secure manner. Connections may be accomplished via different protocols such as TCP/IP. The service provider 1235 may communicate with the database system 1250 in accordance with Java Database Connectivity (JDBC) protocol. Alternatively, database connectivity may be accomplished using a ColdFusion™ server engine either via Open Database Connectivity (ODBC) or native connections.

The database system 1250 may be provided in conformance with a database management system format such as, but not limited to, the Structured Query language (SQL) format. The database system 1250 may also be implemented using Sybase® database management system provided by Sybase® Corporation of Emeryville, Calif. and executing on, for example, an IBM®G RS6000™ workstation AIX® version 4.2.1. Alternatively, the database system 1250 may also be implemented in accordance with the DB2 database product standard available from IBM® Corporation. Furthermore, the database system 1250 may be a SQL Server 7.0 database supporting the ActiveX Data Object (ADO) and ODBC protocols, provided by IBM® Corporation or Oracle® Corporation.

The database system 1250 may further include information such as, but not limited to, database query and access instructions in the form of one or more scripts which, when executed by a processor, serve to store, retrieve, or update data maintained in the database system 1250 according to instructions contained in the scripts, and in particular regarding the data fields to be accessed as well as their arrangement of the fields.

The database system 1250 may be distributed. This may be particularly so when services are offered in a distributed manner with each office site maintains its own local database system. In this case, there may be a centralized data management scheme in addition to individual data management systems and this central data management may regularly communicate with individual local management to ensure data consistency and integrity.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

We claim:

1. A method, comprising:
initializing a first account with a balance, wherein there is a limit on the first account in terms of the total number of withdrawals within each cycle of a pre-determined period;
monitoring the number of withdrawals made from the first account within a cycle of the pre-determined period;
sweeping, upon reaching the limit on the total number of withdrawals, the remaining balance in the first account into a second account;
making each subsequent withdrawal from the second account during the remaining duration of the cycle after the remaining balance is swept into the second account; and
sweeping, when a new cycle of the pre-determined period begins, the entire remaining balance in the second account back into the first account.

2. The method according to claim 1, wherein the first account is a money market deposit account (MMDA).

3. The method according to claim 1, wherein the second account is a negotiable order of withdrawal (NOW) account.

4. The method according to claim 1, wherein both the first account and the second account are insured.

5. The method according to claim 1, wherein said monitoring comprises:
maintaining the current number of withdrawals occurring within a cycle of the pre-determined period;
examining, upon receiving a withdrawal request, whether the current withdrawal recorded reaches the limit on the total number of withdrawals with the current cycle;
making a withdrawal from the first account if the number of withdrawals is lower than the limit.

6. The method according to claim 5, further comprising reinitializing the number of withdrawal when a new cycle begins.

7. The method according to claim 6, further comprising incrementing the number of withdrawals by one after each withdrawal from the second account after the balance in the first account is swept into the second account.

8. The method according to claim 1, further comprising performing a deposit transaction.

9. The method according to claim 8, wherein said performing a deposit transaction comprises:
examining, upon receiving a deposit request with a deposit amount, whether the number of withdrawals within a current cycle exceeds the limit on the total number of withdrawals within each cycle;
depositing the deposit amount into the first account if the number of withdrawals is below the limit; and
depositing the deposit amount into the second account if the number of withdrawals is not below the limit.

10. The method according to claim 1, wherein
each withdrawal is a net withdrawal transaction having a net withdrawal amount corresponding to a negative net transaction amount computed from an aggregated transaction; and
each deposit is a net deposit transaction having a net deposit amount corresponding to a positive net transaction amount computed from an aggregated transaction.

11. The method according to claims 10, further comprising computing the net transaction amount based on transactions aggregated over a pre-specified time frame.

12. The method according to claim 11, wherein said computing comprises:
recording transaction requests received during the pre-specified time frame; and
performing transaction aggregation at the end of the pre-specified time frame.

13. The method according to claim 12, wherein said performing comprises:
retrieving recorded transaction requests received during the pre-specified time frame;
determining the net transaction amount based on the retrieved transaction records;
deriving the net withdrawal amount if the net transaction amount is negative; and
deriving the net deposit amount if the net transaction amount is positive.

14. A method, comprising:
initializing a first account with a balance;
limiting the total number of withdrawals from the first account within each cycle of a pre-determined period;
setting up a second account, wherein the total balance of the first account and the second account is subject to a cap on the amount of balance insured;
monitoring the number of withdrawals from the first account within a cycle of the pre-determined period as well as the total balance with respect to the cap;
sweeping the remaining balance in the first account not exceeding the cap into the second account if the number of withdrawals within a cycle reaches the limit on the total number of withdrawals; and
sweeping, whenever a new cycle of the pre-determined period begins, the entire remaining balance in the second account back into the first account.

15. The method according to claim 14, wherein the first account is a money market deposit account (MMDA).

16. The method according to claim 14, wherein the second account is a negotiable order of withdrawal (NOW) account.

17. The method according to claim 14, further comprising setting up a third account.

18. The method according to claim 17, wherein the third account is not insured.

19. The method according to claim 14, wherein said monitoring comprises:
monitoring each deposit transaction to ensure that the total balance in the first and the second account does not exceed the cap; and
monitoring each withdrawal transaction to ensure that the number of withdrawals from the first account with a cycle of the pre-determined period does not exceed the limit on the total number of withdrawals within the cycle.

20. The method according to claim 19, wherein said monitoring each deposit transaction comprises:
examining, upon receiving a deposit transaction request with a deposit amount, whether the number of withdrawals during the current cycle exceeds the limit on the total number of withdrawal;
accepting deposit to the first or the third account if the number of withdrawals within the current cycle does not exceed the limit; and
accepting deposit to the second or the third account if the number of withdrawals within the current cycle exceeds the limit.

21. The method according to claim 20, wherein said accepting deposit to the first or the third account comprises:
depositing the deposit amount into the third account if the current balance of the first account, before the current deposit, reaches the cap;
determining, if the current balance of the first account does not reach the cap before current deposit, whether the summation of the current balance in the first account and the deposit amount exceeds the cap;
depositing the deposit amount to the first account if the summation does not exceed the cap;
splitting the deposit amount into a first deposit amount and a second deposit amount if the summation exceeds the cap, wherein the current balance and the first amount add up to the cap;
depositing the first deposit amount into the first account; and
depositing the second deposit amount into the third account.

22. The method according to claim 20, wherein said accepting deposit to the second or the third account comprises:
depositing the deposit amount into the third account if the current balance of the second account, before the current deposit, reaches the cap;
determining, if the current balance of the second account, before the current deposit, does not reach the cap, whether the summation of the current balance in the second account and the deposit amount exceeds the cap;
depositing the deposit amount to the second account if the summation does not exceed the cap;
splitting the deposit amount into a third deposit amount and a fourth deposit amount if the summation exceeds the cap, wherein the current balance and the third amount add up to the cap;
depositing the third deposit amount into the second account; and
depositing the fourth deposit amount into the third account.

23. The method according to claim 19, wherein said monitoring each withdrawal transaction comprises:
determining, upon receiving a withdrawal transaction request with a withdrawal amount, whether the current balance in the third account exceeds a threshold amount;
making a withdrawal for the withdrawal amount starting from the third account if the current balance in the third account exceeds the threshold amount; and
making a withdrawal for the withdrawal amount from an account other than the third account if the current balance in the third account does not exceed the threshold amount.

24. The method according to claim 23, wherein said making the withdrawal starting from the third account comprises:
withdrawing the withdrawal amount from the third account if the current balance in the third account is sufficient to cover the withdrawal amount;
splitting the withdrawal amount into a first withdrawal amount and a second withdrawal amount if the current balance in the third account is not sufficient to cover the withdrawal amount, wherein the remaining balance in the third account after a withdrawal for the first withdrawal amount satisfies the threshold amount;
withdrawing the first withdrawal amount from the third account; and
making a withdrawal for the second withdrawal amount from an account other than the third account.

25. The method according to claim 24, wherein said making a withdrawal from an account other than the third account comprises:
withdrawing from the first account if the number of withdrawals in the current cycle is lower than the limit on the total number of withdrawals; and
withdrawing from the second account if the number of withdrawals in the current cycle is not lower than the limit.

26. The method according to claim 25, wherein said withdrawing from the first account comprises:
withdrawing from the first account; and
incrementing the value of a record indicating the number of withdrawals made during the current cycle.

27. The method according to claim 26, wherein said withdrawing from the second account comprises:
sweeping the remaining balance in the first account into the second account if the number of withdrawals during the current cycle equals to the limit;
withdrawing from the second account; and
incrementing the value of a record indicating the number of withdrawals made during the current cycle.

28. The method according to claim 19, further comprising re-initializing the number of withdrawals performed within each cycle of the pre-determined period whenever a new cycle of the pre-determined period begins.

29. The method according to claim 19, wherein
each withdrawal transaction is a net withdrawal transaction with a net withdrawal amount corresponding to a negative net transaction amount computed based on an aggregated transaction; and
each deposit transaction is a net deposit transaction with a net deposit amount corresponding to a positive net transaction amount computed based on an aggregated transaction.

30. The method according to claims 29, further comprising computing the net transaction amount based on transactions aggregated over a pre-specified time frame.

31. The method according to claim 30, wherein said computing comprises:
recording transaction requests received during the pre-specified time frame; and
performing transaction aggregation at the end of the pre-specified time frame.

32. The method according to claim 31, wherein said performing comprises:
retrieving recorded transaction requests received during the pre-specified time frame;
determining the net transaction amount based on the retrieved transaction records;
deriving the net withdrawal amount if the net transaction amount is negative; and
deriving the net deposit amount if the net transaction amount is positive.

33. A system, comprising:
a server configured to perform client finds management;
the server being configured to provide a first account initially holding a balance with a limit on the total number of withdrawals within each cycle of a pre-determined period;
the server being configured to provide a second account; and
a withdrawal transaction mechanism, running on the server, capable of performing
withdrawal transactions from the first or the second account, wherein the withdrawal transaction mechanism monitors the number of withdrawals from the first account within a cycle of the pre-determined period, sweeps the remaining balance in the first account into the second account if the number of withdrawals within a cycle reaches the limit on total number of withdrawals, and sweeps the entire balance in the second account to the first account whenever a new cycle of the pre-determined period begins.

34. The system according to claim 33, wherein the first account is a money market deposit account (MMDA).

35. The system according to claim 33, wherein the second account is a negotiable order of withdrawal (NOW) account.

36. The system according to claim 33, further comprising a deposit transaction mechanism capable of performing deposit transactions on the first or the second account.

37. The system according to claim 36, wherein
the withdrawal transaction mechanism, upon receiving a withdrawal request with a net withdrawal amount, withdraws the net withdrawal amount from the first account if the number of withdrawals is below the limit and withdraws the net withdrawal amount from the second account if the number of withdrawals is not below the limit; and
the deposit transaction mechanism, upon receiving a deposit request to deposit a net deposit amount, deposits the net deposit amount into the first account if the number of withdrawals within the current cycle is below the limit and deposits the net deposit amount into the second account if the number of withdrawals in the current cycle is not below the limit.

38. The system according to claim 37, wherein the withdrawal request and the deposit request are received from a transaction aggregation mechanism.

39. The system according to claim 38, wherein the transaction aggregation mechanism comprises:
a transaction buffering mechanism capable of buffering transaction requests; and
an aggregation mechanism capable of aggregating at least one transaction at the end of a pre-specified time frame to produce a net transaction with a net transaction amount.

40. The system according to claim 39, wherein the aggregation mechanism comprises:
a buffered transaction retrieval mechanism capable of retrieving transaction requests buffered during the pre-specified time frame; and
a net transaction computation mechanism capable of computing a net transaction amount with respect to an account based on at least one buffered transaction retrieved, wherein the net transaction amount corresponds one of the net deposit amount and the net withdrawal amount.

41. The system according to claim 40, further comprising:
a withdrawal transaction aggregator capable of aggregating withdrawal transactions associated with each account to produce an aggregated withdrawal transaction amount for the pre-specified time frame; and
a deposit transaction aggregator capable of aggregating deposit transactions associated with each account to produce an aggregated deposit transaction amount for the pre-specified time frame, wherein
the aggregated withdrawal transaction amount and the aggregated deposit transaction amount are used to derive the net transaction amount,
a positive net transaction amount corresponds to a net deposit amount, and
a negative net transaction amount corresponds to a net withdrawal amount.

42. The system according to claim 39, further comprising an account activity posting mechanism capable of recording each transaction requested with respect to each account.

43. The system according to claim 40, further comprising an account activity reporting mechanism capable of reporting detailed account transaction activities according to the recorded each transaction requested.

44. A system, comprising:
a server configured to perform client funds management;
the server being configured to provide a first account initially holding a balance with a limit on the total number of withdrawals within each cycle of a pre-determined period;
the server being configured to provide a second account, wherein the total balance of the first and the second account is insured up to a cap amount;
the server being configured to provide a third account; and
a withdrawal transaction mechanism, running on the server, capable of performing withdrawal transactions from the first, the second, or the third account, wherein
the withdrawal transaction mechanism monitors the number of withdrawals from the first account within a cycle of the pre-determined period as well as the total balance of the first and the second account, sweeps the remaining balance in the first account not exceeding the cap into the second account if the number of withdrawals within the cycle reaches the limit on total number of withdrawals, and sweeps the entire balance in the second account not exceeding the cap to the first account whenever a new cycle of the pre-determined period begins.

45. The system according to claim 44, wherein the first account is a money market deposit account (MMDA).

46. The system according to claim 44, wherein the second account is a negotiable order of withdrawal (NOW) account.

47. The system according to claim 44, further comprising a deposit transaction mechanism capable of performing deposit transactions on the first, the second, or the third account.

48. The system according to claim 47, wherein
the withdrawal transaction mechanism, upon receiving a withdrawal request with a net withdrawal amount, withdraws the net withdrawal amount from at least one of the first, the second, and the third account so that the number of withdrawals from the first account does not exceed the limit and the total balance of the first and the second account does not exceed the cap; and
the deposit transaction mechanism, upon receiving a deposit request to deposit a net deposit amount, deposits the net deposit amount into at least one of the first, the second, and the third account so that the total balance of the first and the second account does not exceed the cap.

49. The system according to claim 48, wherein the withdrawal request and the deposit request are received from a transaction aggregation mechanism.

50. The system according to claim 49, wherein the transaction aggregation mechanism comprises:
a transaction buffering mechanism capable of buffering transaction requests; and
an aggregation mechanism capable of aggregating at least one transaction at the end of a pre-specified time frame to produce a net transaction with a net transaction amount.

51. The system according to claim 50, wherein the aggregation mechanism comprises:
a buffered transaction retrieval mechanism capable of retrieving transaction requests buffered during the pre-specified time frame; and
a net transaction computation mechanism capable of computing a net transaction amount with respect to an account based on at least one buffered transaction retrieved, wherein the net transaction amount corresponds to one of the net deposit amount and the net withdrawal amount.

52. The system according to claim 51, further comprising:
a withdrawal transaction aggregator capable of aggregating withdrawal transactions associated with each account to produce an aggregated withdrawal transaction amount for the pre-specified time frame; and
a deposit transaction aggregator capable of aggregating deposit transactions associated with each account to produce an aggregated deposit transaction amount for the pre-specified time frame, wherein
the aggregated withdrawal transaction amount and the aggregated deposit transaction amount are used to derive the net transaction amount,
a positive net transaction amount corresponds to a net deposit amount, and
a negative net transaction amount corresponds to a net withdrawal amount.

53. The system according to claim 50, further comprising an account activity posting mechanism capable of recording each transaction requested with respect to each account.

54. The system according to claim 51, further comprising an account activity reporting mechanism capable of reporting detailed account transaction activities according to the recorded each transaction requested.

55. A system, comprising:
a server configured to provide a sweep service;
a terminal including a client portion of the sweep service, by which a fund of the client is swept between a plurality of accounts associated with the client, wherein
the fund is initially placed in a first account that has a limit on total number of withdrawals in each cycle of a predetermined period,
the fund is swept to a second account, upon reaching the limit on the total number of withdrawals within a cycle, and
the fund is swept from the second account back to the first account when a new cycle of the pre-determined period begins.

56. The system according to claim 55, wherein:
the first account is a money market deposit account (MMDA);
the second account is a negotiable order of withdrawal (NOW) account that has no limit on total number of withdrawals within each cycle of pre-determined period.

57. The system according to claim 55, wherein the sweep service further facilitates a deposit made by the client to the associated accounts.

58. The system according to claim 57, wherein the sweep service
performs a withdrawal from the first account before the number of withdrawal within a cycle reaches the limit;
performs a withdrawal from the second account after the fund is swept from the first account to the second account when the number of withdrawals within a cycle reaches the limit; and
performs a deposit to an account where the fund is currently swept to.

59. The system according to claim 55, wherein the client terminal communicates with the sweep service through a network.

60. The system according to claim 55, wherein a withdrawal from the fund is by means including:
a check;
an automatic withdrawal;
a fund transfer via ATM; and
a wired fund transfer.

61. The system according to claim 57, wherein a deposit made by the client to the fund is by means including,:
a check deposit;
an automatic deposit;
an automatic payment; and
a wired fund transfer.

62. The system according to claim 55, wherein the total balance of the first account and the second account is insured subject to a cap.

63. The system according to claim 62, further comprising a third account.

64. The system according to claim 63, wherein the third account is an uninsured account.

65. The system according to claim 63, wherein the sweep service monitors each deposit transaction to ensure that the total balance in the first and the second account does not exceed the cap and first makes a deposit into the first or the second account prior to making the deposit into the third account before the total balance between the first and the second account reaches the cap.

66. The system according to claim 63, wherein the sweep service makes each withdrawal first from the third account if there is sufficient balance in the third account before making the withdrawal from the first or the second account.

67. The system according to claim 55, wherein the sweep service includes offering means for the client to inquire information related to the fund.

68. The system according to claim 67, wherein the information related to the fund includes:
balance of the fund;
net transactions directed at the fund; and
detailed transactions directed at the fund.

69. The system according to claim 55, wherein the sweep service is offered by entities including:
an investment institution;
a bank; and
a service provider providing financial services.
